(19) United States
(12) Patent Application Publication
(10) Pub. No.: US 2024/0015556 A1
(43) Pub. Date: Jan. 11, 2024

(54) CHANNEL MEASUREMENTS AND REPORTING PROCEDURES ASSOCIATED WITH BANDWIDTH PART SWITCHING

(71) Applicant: QUALCOMM Incorporated, San Diego, CA (US)

(72) Inventors: Jing LEI, San Diego, CA (US); Yong LI, San Diego, CA (US); Jing JIANG, San Diego, CA (US)

(21) Appl. No.: 18/348,204

(22) Filed: Jul. 6, 2023

Related U.S. Application Data
(60) Provisional application No. 63/359,286, filed on Jul. 8, 2022.

(51) Int. Cl. H04W 24/10; H04W 24/08

(52) U.S. Cl. CPC H04W 24/10; H04W 24/08

(57) ABSTRACT

Methods, systems, and devices for wireless communication are described. A network entity may transmit, to a user equipment (UE), an indication of a first set of measurement configurations for a first subband of a bandwidth and a second set of measurement configurations for a second subband of the bandwidth. The network entity may determine that the UE has performed a bandwidth part switching from the first subband to the second subband. The network entity may receive a measurement report from the UE indicating a combined measurement result that is based at least in part on a first measurement result for the first subband, a second measurement result for the second subband, a trigger event for the bandwidth part switching, a UE capability, a change of measurement gap configurations for measurements and reporting by the UE after the bandwidth part switching, or a combination thereof.

### CROSS REFERENCE

The present application for patent claims the benefit of U.S. Provisional Patent Application No. 63/359,286 by LEI et al., entitled “CHANNEL MEASUREMENTS AND REPORTING PROCEDURES ASSOCIATED WITH BANDWIDTH PART SWITCHING,” filed Jul. 8, 2022, assigned to the assignee hereof, and expressly incorporated by reference herein.

### TECHNICAL FIELD

The following relates to wireless communication, including channel measurements and reporting procedures associated with bandwidth part switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support channel measurements and reporting procedures associated with bandwidth part (BWP) switching. For example, the described techniques provide for various mechanisms to support a user equipment (UE) resolving and reporting suspended measurement reports in a new source subband after BWP switching. For example, the UE may be operating in a first subband of a bandwidth, such as performing first measurements in the first subband to obtain a first measurement result for serving and/or neighbor cell(s). The first measurement result may include or otherwise be based on layer one (L1) measurement samples (e.g., reference signal received power (RSRP) value(s)) and/or layer three (L3) measurement results (results obtained using a measurement filtering configuration for the L1 measurement samples). However, the UE may perform a BWP switching event that switches the UE from the first subband in the available bandwidth to a second subband in the bandwidth. The UE may identify or otherwise determine that, based on the BWP switching, the measurement gap configuration for the serving and/or neighbor cell(s) has changed. That is, due to BWP switching and an associated change in the reference signal used for measurements and reporting, intra-frequency measurements in the first subband may be switched to inter-frequency measurements for the serving and/or neighbor cell(s), or vice versa, which may result in a change in the measurement gap configurations for the serving and/or neighbor cell(s).

The UE may also perform additional measurements (e.g., second measurements) for the serving and/or neighbor cell(s) in the second subband using a second set of measurement configurations to calculate, determine, or otherwise obtain a second measurement result. In some aspects, the set of measurement configurations used for the first subband may be different from the set of measurement configurations (e.g., cell-specific vs BWP-specific, having different measurement reporting types/configurations, or different cell IDs) used for the second subband. In some aspects, the first and second measurement configurations may include a common or different measurement quantity (e.g., a common or different measurement filtering configuration, a common or different downlink reference signal resource set(s), or other common or different parameters). The UE may generate or otherwise obtain a combined measurement result based on the measurement results in the first and second subbands in response to the BWP switching. Accordingly, the UE may transmit or otherwise provide a measurement report to the network (e.g., via a network entity) indicating the combined measurement results.

A method for wireless communication at a UE is described. The method may include performing a first measurement for a serving cell or a neighbor cell in a first subband of a bandwidth using a first set of measurement configurations to obtain a first measurement result, performing BWP switching from the first subband to a second subband of the bandwidth, identifying a change of measurement gap configurations for the serving cell or the neighbor cell associated with the BWP switching, performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration, and transmitting a measurement report indicating a combined measurement result that is based on the first measurement result, the second measurement result, a trigger event for the BWP switching, a UE capability, the change of measurement gap configurations associated with the BWP switching, or a combination thereof.

An apparatus for wireless communication at a UE is described. The apparatus may include at least one processor and memory coupled (e.g., operatively, communicatively, functionally, electronically, or electrically) with the at least one processor, the memory storing instructions. The instructions may be executable by the at least one processor (e.g., directly, indirectly, after pre-processing, without pre-processing) to cause the UE to perform a first measurement for a serving cell or a neighbor cell in a first subband of a bandwidth using a first set of measurement configurations to obtain a first measurement result, perform BWP switching from the first subband to a second subband of the bandwidth, identify a change of measurement gap configurations for the serving cell or the neighbor cell associated with the BWP switching, perform a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration, and transmit a measurement report indicating a combined measurement result that is based on the first measurement result, the second measurement result, a trigger event for the BWP switching, a UE capability, the change of measurement gap configurations associated with the BWP switching, or a combination thereof.

Another apparatus for wireless communication at a UE is described. The apparatus may include means for performing a first measurement for a serving cell or a neighbor cell in a first subband of a bandwidth using a first set of measurement configurations to obtain a first measurement result, means for performing BWP switching from the first subband to a second subband of the bandwidth, means for identifying a change of measurement gap configurations for the serving cell or the neighbor cell associated with the BWP switching, means for performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration, and means for transmitting a measurement report indicating a combined measurement result that is based on the first measurement result, the second measurement result, a trigger event for the BWP switching, a UE capability, the change of measurement gap configurations associated with the BWP switching, or a combination thereof.

A non-transitory computer-readable medium storing code for wireless communication at a UE is described. The code may include instructions executable by at least one processor to perform a first measurement for a serving cell or a neighbor cell in a first subband of a bandwidth using a first set of measurement configurations to obtain a first measurement result, perform BWP switching from the first subband to a second subband of the bandwidth, identify a change of measurement gap configurations for the serving cell or the neighbor cell associated with the BWP switching, perform a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration, and transmit a measurement report indicating a combined measurement result that is based on the first measurement result, the second measurement result, a trigger event for the BWP switching, a UE capability, the change of measurement gap configurations associated with the BWP switching, or a combination thereof.

Some examples of the method, apparatuses, and non-transitory computer-readable medium described herein may further include operations, features, means, or instructions for identifying a set of weighting factors associated with the first subband and the second subband and combining the first measurement result with a set of measurement samples associated with the second measurement result using the set of weighting factors to obtain the second measurement result, where the measurements and combining may be performed for the serving cell or the neighbor cell.

Some examples of the method, apparatuses, and non-transitory computer-readable medium described herein may further include operations, features, means, or instructions for identifying a set of weighting factors for measurements associated with the first subband and the second subband and combining a first set of measurement samples associated with the first measurement result and the first measurement result with a second set of measurement samples associated with the second measurement result using the set of weighting factors to obtain the second measurement result, where the measurements and combining may be performed for the serving cell or the neighbor cell.

Some examples of the method, apparatuses, and non-transitory computer-readable medium described herein may further include operations, features, means, or instructions for comparing a first set of measurement samples associated with the first measurement result to a measurement threshold, identifying a set of weighting factors associated with the first subband and the second subband, and combining, based on a result of the comparing, the first set of measurement samples, the first measurement result, a second set of measurement samples associated with the second measurement result, or a combination thereof, using the set of weighting factors to obtain the second measurement result.

In some examples of the method, apparatuses, and non-transitory computer-readable medium described herein, the first set of measurement samples and the second set of measurement samples include physical layer measurements, radio resource control layer measurements, or both, that may be used to determine one or more measurement results for the serving cell or the neighbor cell.

Some examples of the method, apparatuses, and non-transitory computer-readable medium described herein may further include operations, features, means, or instructions for comparing a time gap between measuring a first set of measurement samples associated with the first measurement result and measuring a second set of measurement samples associated with the second measurement result to a gap threshold, identifying a set of weighting factors associated with the first subband and the second subband, and combining, based on a result of the comparing, the first set of measurement samples, the first measurement result, a second set of measurement samples associated with the second measurement result, or a combination thereof, using the set of weighting factors to obtain the second measurement result, where the measurements and combining may be performed for the serving cell and the neighbor cell.

Some examples of the method, apparatuses, and non-transitory computer-readable medium described herein may further include operations, features, means, or instructions for combining, based on a measurement threshold, a gap threshold, or a combination thereof, a first set of measurement samples associated with the first measurement result, the first measurement result, a second set of measurement samples associated with the second measurement result, or a combination thereof, using a set of weighting factors to obtain the second measurement result, where the measurements and combining may be performed for the serving cell and the neighbor cell.

Some examples of the method, apparatuses, and non-transitory computer-readable medium described herein may further include operations, features, means, or instructions for combining, based on a UE capability, a measurement priority, an available UE power headroom, or a combination thereof, a first set of measurement samples associated with the first measurement result, the first measurement result, a second set of measurement samples associated with the second measurement result, or a combination thereof, to obtain the second measurement result for the serving cell or the neighbor cell.

Some examples of the method, apparatuses, and non-transitory computer-readable medium described herein may further include operations, features, means, or instructions for combining a first set of measurement samples associated with the first measurement result, the first measurement result, a second set of measurement samples associated with the second measurement result, or a combination thereof, to obtain the second measurement result for the serving cell or the neighbor cell.

Some examples of the method, apparatuses, and non-transitory computer-readable medium described herein may further include operations, features, means, or instructions for receiving an indication of a combining scheme for combining a first set of measurement samples associated with the first measurement result, the first measurement result, a second set of measurement samples associated with the second measurement result, or a combination thereof, to obtain the second measurement result for the serving cell or the neighbor cell.

Some examples of the method, apparatuses, and non-transitory computer-readable medium described herein may further include operations, features, means, or instructions for determining that a measurement and reporting interval of the first set of measurement configurations overlaps with the BWP switching, suspending measurement and reporting for the serving cell and the neighbor cell during the BWP switching, and transmitting, after the BWP switching and based on the overlap, a set of UE assistance information messages or scheduling request messages requesting transmission of the first measurement result in the second subband.

Some examples of the method, apparatuses, and non-transitory computer-readable medium described herein may further include operations, features, means, or instructions for determining that a measurement and reporting interval of the first set of measurement configurations overlaps with the BWP switching, suspending measurement and reporting for the serving cell and the neighbor cell during BWP, and multiplexing, after the BWP switching and based on the overlap, the first measurement result and additional uplink information in a message transmitted in the second subband.

In some examples of the method, apparatuses, and non-transitory computer-readable medium described herein, the first measurement result may be indicated in a MAC header of the message.

Some examples of the method, apparatuses, and non-transitory computer-readable medium described herein may further include operations, features, means, or instructions for determining that a measurement and reporting interval of the first set of measurement configurations overlaps with the BWP switching, suspending the measurement and reporting for the serving cell and the neighbor cell during BWP switching, and measuring, after the BWP switching and based on the overlap, a first set of measurement samples for the serving cell or the neighbor cell using a set of weighting factors to obtain an updated first measurement result, where the combined measurement result may be based on the updated first measurement result.

Some examples of the method, apparatuses, and non-transitory computer-readable medium described herein may further include operations, features, means, or instructions for determining that a measurement and reporting interval of the first set of measurement configurations overlaps with the BWP switching, suspending measurement and reporting for the serving cell and the neighbor cell during BWP switching, and comparing, after the BWP switching and based on the overlap, a timing gap between the first measurement result suspended during BWP switching and the second measurement result to a timing gap threshold, where combined measurement result may be based on a result of the comparing.

Some examples of the method, apparatuses, and non-transitory computer-readable medium described herein may further include operations, features, means, or instructions for determining that a measurement and reporting interval of the first set of measurement configurations overlaps with the BWP switching, suspending measurement and reporting for the serving cell and the neighbor cell during BWP switching, and transmitting, after the BWP switching and based on the overlap, a message requesting transmission of the first measurement result suspended during BWP switching or a message where the first measurement result suspended during BWP switching may be multiplexed with additional uplink information based on a reporting resource size of the second set of measurement configurations, a timing gap threshold between the first measurement result and the second measurement result, or a combination thereof.

Some examples of the method, apparatuses, and non-transitory computer-readable medium described herein may further include operations, features, means, or instructions for determining that a measurement and reporting interval of the first set of measurement configurations overlaps with the BWP switching, suspending measurement and reporting for the serving cell and the neighbor cell during BWP switching, and selecting, after the BWP switching and based on the overlap, a transmission scheme for reporting the first measurement result based on a UE capability, a measurement priority of the first measurement result, an available UE power headroom, a measurement gap configuration for the second measurement result, a reporting configuration for the second measurement result, or a combination thereof.

Some examples of the method, apparatuses, and non-transitory computer-readable medium described herein may further include operations, features, means, or instructions for determining that a measurement and reporting interval of the first set of measurement configurations overlaps with the BWP switching, suspending measurement and reporting for the serving cell and the neighbor cell during BWP switching, and autonomously selecting, after the BWP switching and based on the overlap, a transmission scheme for reporting the first measurement result.

Some examples of the method, apparatuses, and non-transitory computer-readable medium described herein may further include operations, features, means, or instructions for receiving an indication of a transmission scheme for reporting the first measurement result in the second subband, determining that a measurement and reporting interval of the first set of measurement configurations overlaps with the BWP switching, suspending measurement and reporting for the serving cell and the neighbor cell during BWP switching, and transmitting, after the BWP switching and based on the overlap, the first measurement result according to the transmission scheme.

Some examples of the method, apparatuses, and non-transitory computer-readable medium described herein may further include operations, features, means, or instructions for determining that the first set of measurement configurations may be different from the second set of measurement configurations, that a first reporting configuration of the first set of measurement configurations may be different from a second reporting configuration of the second set of measurement configurations, or both, and a change of measurement gap configurations for the serving cell or the neighbor cell during BWP switching and identifying, based on the determining, a timing gap threshold for reporting the first measurement result in the second subband.

Some examples of the method, apparatuses, and non-transitory computer-readable medium described herein may further include operations, features, means, or instructions for identifying a triggering event triggering the BWP switching, where the timing gap threshold may be based on a timing of the triggering event, a type of the trigger event, a UE capability, the measurement gap configurations for the second measurement of the serving cell or the neighbor cell.

In some examples of the method, apparatuses, and non-transitory computer-readable medium described herein, the change of measurement gap configurations include a change of a reference signal type, a reference signal resource configuration, a gap configuration, a length of measurements, a number of intra-frequency measurements, a number of inter-frequency measurements, a window configuration, a measurement periodicity, a measurement offset time, a reporting condition, a priority level, or a combination thereof, for the measurement and reporting for the serving cell and the neighbor cell.

A method for wireless communication at a network entity is described. The method may include transmitting, to a UE, an indication of a first set of measurement configurations for a first subband of a bandwidth and a second set of measurement configurations for a second subband of the bandwidth, determining that the UE has performed a BWP switching from the first subband to the second subband, and receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

An apparatus for wireless communication at a network entity is described. The apparatus may include at least one processor and memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the network entity to transmit, to a UE, an indication of a first set of measurement configurations for a first subband of a bandwidth and a second set of measurement configurations for a second subband of the bandwidth, determine that the UE has performed a BWP switching from the first subband to the second subband, and receive a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

Another apparatus for wireless communication at a network entity is described. The apparatus may include means for transmitting, to a UE, an indication of a first set of measurement configurations for a first subband of a bandwidth and a second set of measurement configurations for a second subband of the bandwidth, means for determining that the UE has performed a BWP switching from the first subband to the second subband, and means for receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

A non-transitory computer-readable medium storing code for wireless communication at a network entity is described. The code may include instructions executable by at least one processor to transmit, to a UE, an indication of a first set of measurement configurations for a first subband of a bandwidth and a second set of measurement configurations for a second subband of the bandwidth, determine that the UE has performed a BWP switching from the first subband to the second subband, and receive a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

Some examples of the method, apparatuses, and non-transitory computer-readable medium described herein may further include operations, features, means, or instructions for transmitting an indication of a set of weighting factors associated with the first subband and the second subband to the UE, where the combined measurement result may be based on the set of weighting factors.

Some examples of the method, apparatuses, and non-transitory computer-readable medium described herein may further include operations, features, means, or instructions for transmitting an indication of a combining scheme for the UE to combine a first set of measurement samples associated with the first measurement result, the first measurement result, a second set of samples associated with the second measurement result, or a combination thereof, where the combined measurement result may be based on the combining scheme.

Some examples of the method, apparatuses, and non-transitory computer-readable medium described herein may further include operations, features, means, or instructions for transmitting an indication of a timing gap threshold for a timing gap between the first measurement result and the second measurement result, where the combined measurement result may be based on the timing gap threshold.

Some examples of the method, apparatuses, and non-transitory computer-readable medium described herein may further include operations, features, means, or instructions for receiving a message from the UE requesting transmission of the first measurement result in the second subband.

### BRIEF DESCRIPTION OF THE DRAWINGS

FIG. 1 illustrates an example of a wireless communications system that supports channel measurements and reporting procedures associated with bandwidth part (BWP) switching in accordance with one or more aspects of the present disclosure.

FIG. 2 illustrates an example of a wireless communication system that supports channel measurements and reporting procedures associated with BWP switching in accordance with one or more aspects of the present disclosure.

FIG. 3 illustrates an example of a message configuration that supports channel measurements and reporting procedures associated with BWP switching in accordance with one or more aspects of the present disclosure.

FIG. 4 illustrates an example of a method that supports channel measurements and reporting procedures associated with BWP switching in accordance with one or more aspects of the present disclosure.

FIGS. 5 and 6 show block diagrams of devices that support channel measurements and reporting procedures associated with BWP switching in accordance with one or more aspects of the present disclosure.

FIG. 7 shows a block diagram of a communications manager that supports channel measurements and reporting procedures associated with BWP switching in accordance with one or more aspects of the present disclosure.

FIG. 8 shows a diagram of a system including a device that supports channel measurements and reporting procedures associated with BWP switching in accordance with one or more aspects of the present disclosure.

FIGS. 9 and 10 show block diagrams of devices that support channel measurements and reporting procedures associated with BWP switching in accordance with one or more aspects of the present disclosure.

FIG. 11 shows a block diagram of a communications manager that supports channel measurements and reporting procedures associated with BWP switching in accordance with one or more aspects of the present disclosure.

FIG. 12 shows a diagram of a system including a device that supports channel measurements and reporting procedures associated with BWP switching in accordance with one or more aspects of the present disclosure.

FIGS. 13 through 17 show flowcharts illustrating methods that support channel measurements and reporting procedures associated with BWP switching in accordance with one or more aspects of the present disclosure.

### DETAILED DESCRIPTION

User equipment (UE) may support or otherwise be configured to communicate on a reduced bandwidth (e.g., on a subband of the available bandwidth). For example, once the UE connects to a network entity (e.g., a serving and/or neighbor cell) the UE may begin performing channel measurement and reporting procedures for the subband according to a set of measurement configurations where the UE measures channel conditions in the subband and reports those to the network entity. The UE may also support bandwidth part (BWP) switching where the UE is moved from the source subband to a target subband within the available bandwidth. In some instances, the UE may measure or otherwise obtaining a first measurement for the source subband, but switch to the second subband due to BWP switching before transmitting the first measurement report (e.g., creating a suspended measurement report in some aspects). This suspended measurement report may create uncertainty between the UE and network regarding the measurement procedures. For example, there may be uncertainty around what the UE is to include in its subsequent measurement reporting (and what the network may expect) in the second subband.

Accordingly, aspects of the described techniques relate to improved methods, systems, devices, and apparatuses that support channel measurements and reporting procedures associated with BWP switching. For example, the described techniques provide for various mechanisms to support a UE resolving and reporting suspended measurement reports in a new source subband after BWP switching. For example, the UE may be operating in a first subband of a bandwidth, such as performing first measurements in the first subband to obtain a first measurement result for serving and/or neighbor cell(s). The first measurement result may include or otherwise be based on layer one (L1) measurement samples (e.g., reference signal received power (RSRP) value(s)) and/or layer three (L3) measurement results (results obtained using a measurement filtering configuration for the L1 measurement samples). However, the UE may perform a BWP switching event that switches the UE from the first subband in the available bandwidth to a second subband in the bandwidth. The UE may identify or otherwise determine that, based on the BWP switching, the measurement gap configuration for the serving and/or neighbor cell(s) has changed. That is, due to BWP switching and an associated change in the reference signal used for measurements and reporting, intra-frequency measurements in the first subband may be switched to inter-frequency measurements for the serving and/or neighbor cell(s), or vice versa, which may result in a change in the measurement gap configurations for the serving and/or neighbor cell(s).

The UE may also perform additional measurements (e.g., second measurements) for the serving and/or neighbor cell(s) in the second subband using a second set of measurement configurations to calculate, determine, or otherwise obtain a second measurement result. In some aspects, the set of measurement configurations used for the first subband may be different from the set of measurement configurations (e.g., cell-specific vs BWP-specific, having different measurement reporting types/configurations, or different cell IDs) used for the second subband. In some aspects, the first and second measurement configurations may include a common or different measurement quantity (e.g., a common or different measurement filtering configuration, a common or different downlink reference signal resource set(s), or other common or different parameters). The UE may generate or otherwise obtain a combined measurement result based on the measurement results in the first and second subbands in response to the BWP switching. Accordingly, the UE may transmit or otherwise provide a measurement report to the network (e.g., via a network entity) indicating the combined measurement results.

Aspects of the disclosure are initially described in the context of wireless communications systems. Aspects of the disclosure are further illustrated by and described with reference to apparatus diagrams, system diagrams, and flowcharts that relate to channel measurements and reporting procedures associated with BWP switching.

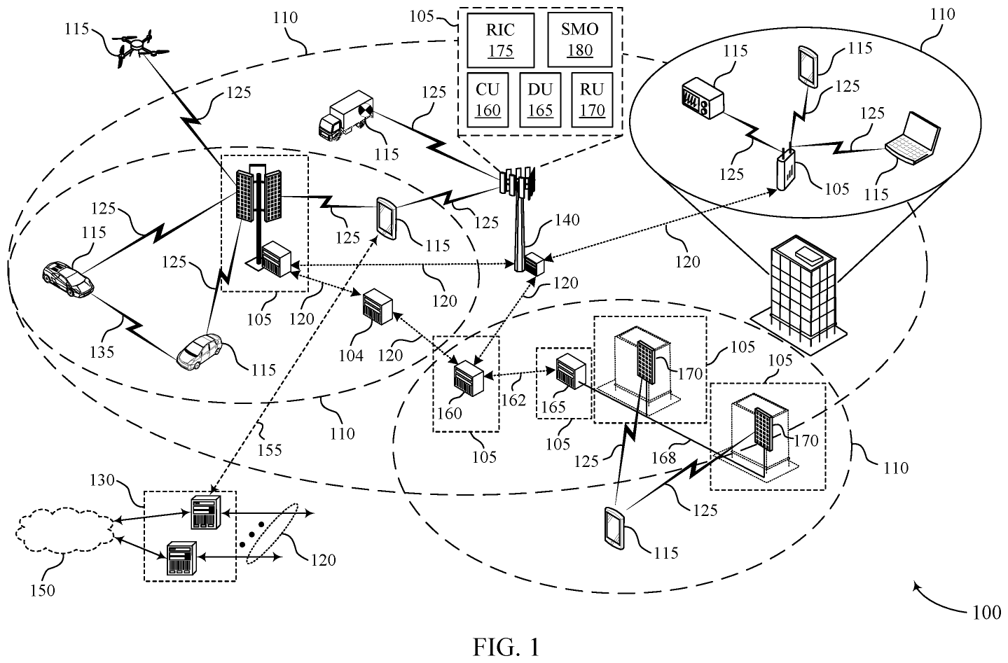

FIG. 1 illustrates an example of a wireless communications system 100 that supports channel measurements and reporting procedures associated with BWP switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support channel measurements and reporting procedures associated with BWP switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may perform a first measurement for a serving cell or a neighbor cell in a first subband of a bandwidth using a first set of measurement configurations to obtain a first measurement result. The UE 115 may perform BWP switching from the first subband to a second subband of the bandwidth. The UE 115 may identify a change of measurement gap configurations for the serving cell or the neighbor cell associated with the BWP switching. The UE 115 may perform a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The UE 115 may transmit a measurement report indicating a combined measurement result that is based at least in part on the first measurement result, the second measurement result, a trigger event for the BWP switching, a UE capability, the change of measurement gap configurations associated with the BWP switching, or a combination thereof.

A network entity 105 may transmit, to a UE 115, an indication of a first set of measurement configurations for a first subband of a bandwidth and a second set of measurement configurations for a second subband of the bandwidth. The network entity 105 may determine that the UE 115 has performed a BWP switching from the first subband to the second subband. The network entity 105 may receive a measurement report from the UE 115 indicating a combined measurement result that is based at least in part on a first measurement result for the first subband, a second measurement result for the second subband, a trigger event for the BWP switching, a UE capability, a change of measurement gap configurations for measurements and reporting by the UE after the BWP switching, or a combination thereof.

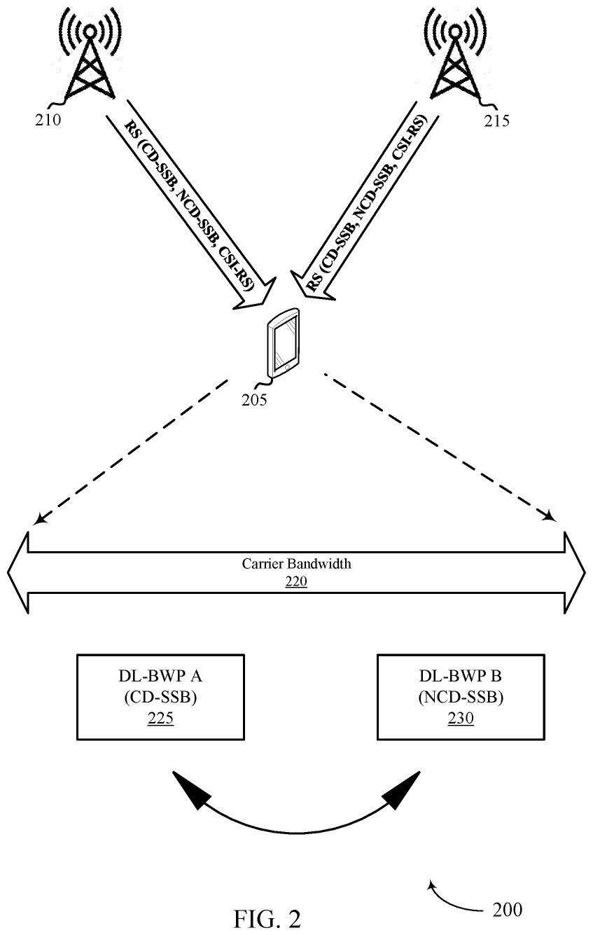

FIG. 2 illustrates an example of a wireless communication system 200 that supports channel measurements and reporting procedures associated with BWP switching in accordance with one or more aspects of the present disclosure. Wireless communication system 200 may implement aspects of wireless communication system 100. Wireless communication system 200 may include UE 205, network entity 210, and network entity 215, which may be examples of the corresponding devices described herein. For example, network entity 210 may be an example of a serving cell of UE 205 and network entity 215 may be an example of a neighbor cell of UE 205.

UE 205 may generally be configured to or otherwise support wireless communications on a subband within a carrier bandwidth 220. UE 205 may support or otherwise be configured to communicate on a reduced bandwidth (e.g., on a subband of the available bandwidth). For example, once UE 205 connects to a network entity (e.g., network entity 210, which may be a serving cell in this example) UE 205 may begin performing channel measurement and reporting procedures for the subband according to a set of measurement configurations. This may include UE 205 measuring channel conditions in the subband and reports those to network entity 210 (e.g., using various types of reference signals).

For example, in some situations the set of measurement configurations for a subband may identify a resource type for the channel measurement and reporting. One type of reference signal may include a channel state information-reference signal (CSI-RS) configured on a downlink resource available for measurement by UE 205. Another type may include a cell defining-synchronization signal block (CD-SSB) configured on a downlink resource available for measurement by UE 205. Generally, the CD-SSB may include a cell-specific SSB configured as part of a cell-specific measurement configuration (e.g., as opposed to a BWP-specific measurement configuration).

Another type of reference signal may include a non-cell defining-SSB (NCD-SSB) configured on a downlink resource available for measurement by UE 205. Generally, the NCD-SSB may be used when UE 205 is operating or otherwise in a connected mode. In some examples, the NCD-SSB may be used when UE 205 is a reduced capability UE (e.g., a reduced-bandwidth UE). In some examples, the NCD-SSB may be used when UE 205 is an advanced UE that is otherwise configured to or otherwise supports NCD-SSB measurements for channel measurement and reporting. When configured, this may include the network transmitting or otherwise providing to UE 205 an indication of an absolute frequency SSB (absoluteFrequencySSB) and/or an SSB periodicity (ssb-periodicity) for the NCD-SSB. Other properties within the set of measurement configurations, such as physical cell identifier (PCI), SSB physical broadcast channel (PBCH) block power, or SSB positions in a burst, may be configured with the same values as the serving cell's CD-SSB.

In some aspects, when a BWP inactivity timer (bwp-InactivityTimer) has expired and the default BWP is not configured for a reduced capability UE, the reduced capability UE may switch to an initial downlink BWP configured for reduced capability UE (initialDownlinkBWP-RedCap), when configured. If the network configures SSB-based random access (RA) (e.g., RACH-ConfigCommon) only for the uplink BWPs if the linked downlink BWPs are the initial downlink BWPs or the downlink BWPs containing the SSB associated to the initial downlink BWP or for reduced capability UE's downlink BWPs are associated with a NCD-SSB (nonCellDefiningSSB). A BWP-specific servingCellMO may be defined under the BWP-DownlinkDedicated indication, the SSB defined in this servingCellMO is the reference SSB to be used for serving cell measurements and reporting when the UE is in this active BWP. If the field is absent, the SSB defined in servingCellMO under ServingCellConfig may be the reference SSB to be used for serving cell measurements and reporting. This reference SSB may be used to define intra-frequency measurements. A reduced capability UE may be configured with multiple NCD-SSBs, provided that each BWP is configured with at most one SSB.

If NCD-SSB is configured in a dedicated downlink BWP for a reduced capability UE, the UE operating in this BWP may use this SSB for the purposes for which it would otherwise have used the CD-SSB of the serving cell (e.g., synchronization, automatic gain control (AGC), or measurements). Other parameters of the BWP configuration that refer to an SSB (e.g., such as the SSB configured in the QCL-Info information element (IE), the ssb-Index configured in the RadioLinkMonitoringRS, the CFRA-SSB-Resource, or the PRACH-ResourceDedicatedBFR) may refer implicitly to this NCD-SSB. The periodicity and half-frame index of NCD-SSB may be different from CD-SSB. In some aspects, NCD-SSB can also be used other UEs (e.g., non-reduced capability UEs) for the purposes for which it would otherwise have used the CD-SSB of the serving cell. For reduced capability UEs, a neighbor cell's NCD-SSB may not be configured on the same frequency location as the serving cell's CD-SSB.

UE 205 may also support BWP switching where 205 is moved from a source subband (e.g., subband 225, which includes a downlink BWP A defined as a CD-SSB) to a target subband (e.g., subband 230, which includes a downlink BWP B defined as NCD-SSB) within the available bandwidth (e.g., carrier bandwidth 220). In one non-limiting example, when UE 205 is operating in the downlink BWP A, UE 205 performs measurements and reporting based on cell-specific measurement configurations defined under ServingCellConfig, wherein the reference signal type is the CD-SSB. When UE 205 is operating in downlink BWP B, UE 205 performs measurements and reporting based on BWP-specific measurement configurations defined under BWP-DownlinkDedicated, wherein the reference signal type is NCD-SSB. Among the different measurement configurations, the CD-SSB and NCD-SSB may have the same transmit power, subcarrier-spacing (SCS) and block indexes. However, the periodicities may be different and the SSB bursts may be transmitted in different half-frames (e.g., CD-SSB may be transmitted on the first half-frame with a 20 ms periodicity, whereas NCD-SSB may be transmitted on the second half-frame with an 80 ms periodicity).

In some instances, this may result in UE 205 measuring or otherwise obtaining a first measurement for the source subband (e.g., subband 225), but switching to the second subband (e.g., subband 230) due to BWP switching before the first measurement report (e.g., creating a suspended measurement report in some aspects) is provided. That is, this may create uncertainty between UE 205 and the network regarding the measurements and reporting procedures. For example, UE 205 performing measurements in the first subband and switching to the second subband may be unsure what to include in its subsequent measurement reporting (and the network may be unsure what to expect) in the second subband. That is, this creates an uncertainty regarding how to deal with measurements obtained in downlink BWP A when UE 205 switches to downlink BWP B (e.g., discard those measurement results, or combine them somehow with measurement results on downlink BWP B). Moreover, when UE 205 suspends the periodic reporting for measurements (when configured) due to BWP switching, the BWP switching may be triggered by a timer of UE 205 that is unknown by the serving cell (e.g., network entity 210). This creates the uncertainty regarding whether—and if so, how—UE 205 requests a grant of uplink resources to provide the measurement report for downlink BWP A on downlink BWP B after BWP switching.

That is, due to the introduction of NCD-SSB reference signal types, UEs may be provided with cell-specific and BWP-specific measurement and reporting procedures (e.g., measurement configuration(s)). After successful access-stratum (AS) security activation, UE 205 may initiate the measurement and reporting procedures. The report type (reportType) for the associated report configuration (reportConfig) may be periodic, event triggered (eventTriggered), or condition-triggered according to a configuration (condTriggerConfig). Accordingly, the UE's measurement and reporting may be interrupted by active BWP switching. The BWP switching may be triggered by events such as a BWP inactivity timer expiration, RRC reconfiguration, receiving a DCI indicating active BWP switching, a RA procedure, acquisition of modified system information (SI) outside the active BWP, constant clear-channel assessment (CCA) failures on shared spectrum, or other events.

Accordingly, aspects of the techniques described herein provide various UE and/or network procedures and/or signaling support to handle interruptions of measurements and/or reporting due to BWP switching. In some aspects, this may be based on different downlink reference signal types/resources being configured in the source BWP (e.g., the active BWP prior to BWP switching) and the target BWP (e.g., the active BWP after BWP switching).

For example, UE 205 may be performing a first measurement for a serving cell (e.g., network entity 210) or a neighbor cell (e.g., network entity 215) in a first subband (e.g., subband 225) of a bandwidth (e.g., carrier bandwidth 220). The measurements may be performed according to a first set of measurement configurations to obtain a first measurement result. The first set of measurement configurations in this non-limiting example may include a cell-specific measurement configuration including configuring the reference signal type as CD-SSB for UE 205 to use for channel performance measurement and reporting. Generally, the first measurement result may correspond to a L3 measurement result obtained by applying a measurement filtering configuration to L1 measurement samples (e.g., a first set of measurement samples associated with the first measurement result).

That is, measurements and reporting procedures according to a measurement configuration may generally include UE 205 performing various L1 or physical layer measurements on the physical channel between UE 205 and network entity 210 (e.g., the serving cell) or on the physical channel between UE 205 and network entity 215 (e.g., the neighbor cell). The results of the physical layer measurements may be considered measurement samples, with the measurement samples corresponding to RSRP, reference signal received quality (RSRQ), throughput, or interference information. These measurement samples may be used by higher layer functions (e.g., L3 or RRC) applying various measurement filtering configurations to identify or otherwise determine various measurement results.

More particularly, the measurement configurations configured by the network for UE 205 may include various items, such as the measurement object (MeasObject), reporting configuration(s), measurement identities (MeasID), quantity configuration(s), or measurement gap configuration(s). The measurement object generally defines the objects (e.g., reference signals) that UE 205 is to use for intra- or inter-frequency measurements and reporting. The reporting configuration(s) generally define a list of reporting configurations including one or more reporting configurations per measurement object (also indicating the reference signal type). The measurement identities generally defines a list of measurement identities linking one measurement object to one reporting configuration. The quantity configuration generally defines filter coefficients for the L3 filtering of the measurement samples (e.g., the measurement filtering configuration). The measurement gap configuration generally defines the periods that UE 205 may use to perform measurements and reporting (e.g., a first half-frame used for CD-SSB vs a second half-frame used for NCD-SSB). The UE may be configured with one or more measurement configurations for some or all of the available subband(s) (e.g., via RRC signaling).

UE 205 may perform BWP switching from the first subband to a second subband (e.g., subband 230) of the bandwidth. For example, the BWP switching may be triggered by any of the potential triggering events discussed above. As a result, UE 205 may be connected to or otherwise configured to communicate on the second subband (e.g., downlink BWP B, in this example) instead of the first subband (e.g., downlink BWP A, in this example).

UE 205 may also identify or otherwise determine a change of measurement gap configurations for the serving cell or the neighbor cell associated with the BWP switching. That is, UE 205 may identify or otherwise determine that the measurement gap configuration(s) in the measurement configuration(s) for the second subband (the new source subband) is different from the measurement gap configuration(s) in the measurement configuration(s) for the first subband (the previous source subband). As one non-limiting example, UE 205 may identify or otherwise determine that a change in the reference signal type for the measurement configuration of downlink BWP A (e.g., the first set of measurement configurations) may result in intra-frequency measurements for a serving or neighbor cell in the first subband changing (e.g., due to BWP switching) to inter-frequency measurements for the serving or neighbor cell, or vice versa. As a result, the measurement gap configurations in the first set of measurement configurations for the first subband may change in the second set of measurement configurations of the second subband.

UE 205 may also perform second measurements for the serving cell and/or neighbor cell in the second subband (e.g., downlink BWP B, in this example). For example, UE 205 may identify or otherwise determine a second set of measurement configurations for the serving and/or neighbor cell in the second subband in response to BWP switching to the second subband. UE 205 may use the second set of measurement configurations for the second subband for performing channel performance measurements and reporting in the second subband to obtain a second measurement result. As discussed above, the second measurement result may be based on or otherwise derived from a second set of measurement samples in the second subband. For example and after BWP switching, UE 205 may be collecting L1 or physical layer measurement samples (e.g., RSRP, interference, or channel quality information (CQI)) for the physical channel in the second subband. The measurement samples in the second subband may be used by L3 functions applying a measurement configuration to the measurement samples of obtain or otherwise derive the second measurement result for the second subband. Although the measurement configuration(s) differ for the first subband and the second subband, it is to be understood that in this non-limiting example the measurement filtering configuration are common (e.g., the same) between the different measurement configuration(s). That is, although various values are different for some or all of the items signaled in each measurement configuration, it is to be understood that the value for the L3 measurement filtering configurations are the same, common, or otherwise shared among the different measurement configuration(s) for the old and new source subbands.

Accordingly, at this post-BWP switching point UE 205 may have unreported measurement results for the first subband (e.g., the first measurement result), yet has switched to and obtained measurement results for the second subband (e.g., the second measurement result).

UE 205 may transmit or otherwise provide a measurement report indicating a combined measurement result to its serving cell (e.g., network entity 210). The combined measurement result may generally be based on the first measurement result and/or the second measurement result. In some aspects, if the measurement configuration for the target BWP is different from that of the source BWP, various options may be applied—alone or in any combination—by UE 205 when identifying or otherwise determining the combined measurement result. Again, in some aspects this may be based on the same, common, or otherwise shared measurement quantity being configured in both the source BWP and the target BWP.

In some examples, the combined measurement result indicated in the measurement report may be based on a UE capability report. That is, UE 205 may transmit or otherwise provide a UE capability report indicating supported capabilities for BWP switching and/or combined measurement report signaling. The option selected for the combining scheme may be based on the capabilities of UE 205 as signaled in the UE capability report.

In some examples, the combined measurement result indicated in the measurement report may be based on a change of the measurement gap configurations for measurements and reporting by UE 205 after BWP switching. As discussed above, the measurement gap configuration(s) for the measurement configuration(s) of the first subband may differ (e.g., change) from the measurement gap configuration(s) of the second subband. The option selected for the combining scheme may be based on the change in measurement gap configuration(s), what the measurement gap configuration was in the first subband, and/or what the measurement gap configuration in the second subband. In some examples, the combined measurement result indicated in the measurement report may be based on the triggering event for the BWP switching. As discussed above, the BWP switching may be triggered by different triggering event types. In some examples, selecting the option(s) for the combining scheme may be based on which triggering event caused the BWP switching.

A first option for a combining scheme may include UE 205 identifying or otherwise determining a set of weighting factors associated with the first subband (e.g., the source BWP) and/or the second subband (e.g., the target BWP). UE 205 may combine the first measurement result with a set of measurement samples associated with the second measurement result using the set of weighting factors to obtain the second measurement result (e.g., used to identify or otherwise obtain the combined measurement result). As one non-limiting example, this may include UE 205 keeping the last measured result(s) (e.g. M source) for the common measurement quantity obtained prior to BWP switching. UE 205 may combine the last measured results with the new measurement samples (e.g., S_{target,k}) obtained after BWP switching based on the set of weighting factors. The set of weighting factors may include a set of filtering/scaling parameters (e.g., α, β) configured for the target BWP according to:

M_{target,0}=β*M_{source}+(1−β)*S_{target,0}

M_{target,k}=α*M_{target,k-1}+(1−α)*S_{target,k}, where K>0

According, in this first option for the combining scheme UE 205 may combine the first measurement result of the first subband with measurement samples of the second subband to derive the second measurement result. The combined measurement result indicated in the measurement report may refer to the obtained second measurement result.

A second option for a combining scheme may include UE 205 identifying or otherwise determining the set of weighting factors associated with the first subband and/or the second subband (e.g., α, β). UE 205 may combine the first set of measurement samples used to obtain the first measurement result as well as the first measurement result with a second set of measurement samples associated with the second measurement result using the set of weighting factors to obtain the second measurement result (e.g., used to identify or otherwise obtain the combined measurement result). As one non-limiting example, this may include UE 205 keeping the last measured samples(s) (e.g., S_{source}) and the first measurement result (e.g., M_{source}) for the common measurement quantity obtained prior to BWP switching. UE 205 may combine the last measured samples and results {M_{source}, S_{source}} with the new measurement samples (e.g., S_{target}) obtained after BWP switching based on the set of weighting factors. The set of weighting factors may include a set of filtering/scaling parameters (e.g., α, β) configured for the target BWP according to:

M_{target,0}=β₁*M_{source}+β₂*S_{source}+β₃*S_{target,0}

M_{target,k}=α*M_{target,k-1}+(1−α)*S_{target,k}, where K>0

Accordingly, the second option for the combining scheme may include UE 205 combing both the measurement samples and measurement results from the first subband with the measurement samples of the second subband to identify or otherwise determine the second measurement result for the second subband, which is signaled as the combined measurement result in the measurement report.

A third option of the combining scheme may include UE 205 selecting the first option or the second option for the combining scheme based on comparing the samples from the first subband to a threshold (e.g., a measurement threshold). For example, UE 205 may compare the first set of measurement samples (e.g., S_{source}) to the measurement threshold and select the combining scheme based on a result of the comparison. For example, UE 205 may compare the last sample(s) (e.g., S_{source}) against threshold(s) (e.g., RSRP, RSRQ, or SINR) such as T_{target,low} and/or T_{target,up} and select the combining scheme according to the second option (e.g., using M_{source}, S_{source} & S_{target}) if T_{target,low}≤S_{source}≤T_{target,up}. Otherwise, UE 205 may select the combining scheme according to the first option (e.g., using M_{source} & S_{target}) In this third option, UE 205 may use the set of weighting factors discussed above according to the combining scheme determined based on the result of the comparison (e.g., using some combination of M_{source}, S_{source}, & S_{target}).

A fourth option of the combining scheme may include UE 205 selecting the first option or the second option for the combining scheme based on comparing the age of the samples for the first subband to the age of the samples for the second subband. For example, this may include UE 205 comparing a time gap between measuring the first set of measurement samples (S_{source}) associated with the first measurement result and measuring the second set of samples (S_{target}) associated with the second measurement result. For example, UE 205 may compare the time gap (G_{source,target}) between the sampling time for S_{source} and the sampling time for S_{target} with a threshold/timer (e.g., gap threshold, (T_{gap})) and select the combining scheme based on a result of the comparing. For example, UE 205 may select the combining scheme according to the second option (e.g., using M_{source} S_{source}, & S_{target}) if G_{source,target}≤T_{gap}. Otherwise, UE 205 may select the combining scheme according to the first option (e.g., using M_{source} & S_{target}). In this fourth option, UE 205 may use the set of weighting factors discussed above according to the combining scheme determined based on the result of the comparison (e.g., using some combination of M_{source}, S_{source}, & S_{target}).

A fifth option of the combining scheme may include UE 205 selecting the first option or the second option for the combining scheme based on comparing the age of the samples as well as comparing the samples to the measurement threshold (e.g., combining options three and four discussed above). That is, UE 205 may use both the measurement threshold discussed for option three and the gap threshold discussed for option four when selecting between the first or second combining schemes. In some options, the gap threshold and the measurement threshold may have equal weight when evaluating the results of the comparison (e.g., both thresholds must be satisfied). In some options, the measurement threshold or the gap threshold may be given priority over the other (e.g., at least one threshold must be satisfied). In some options, another set of weighting factors may be applied to one or both thresholds. In this fifth option, UE 205 may again use the set of weighting factors discussed above according to the combining scheme determined based on the result of the comparison (e.g., using some combination of M_{source}, S_{source}, & S_{target}).

A sixth option of the combining scheme may include UE 205 selecting the different options (e.g., options one though four) for the combining scheme based on the UE capabilities, the priority of the measurement quantity and/or the available power headroom of the UE. This sixth option may again include UE 205 using the set of weighting factors discussed above according to the combining scheme determined based on the result of the UE capability, measurement quantity priority and/or the UE's available power headroom (e.g., using some combination of M_{source}, S_{source}, & S_{target}).

A seventh option of the combining scheme may include selecting among the options for the combining scheme may be left up to UE implementation. That is, UE 205 may apply the set of weighting factors discussed above according to the combining scheme determined based on UE autonomously selecting the combining scheme (e.g., using some combination of M_{source}, S_{source}, & S_{target}).

An eighth option of the combining scheme may include the network explicitly/implicitly signaling which combing scheme to be applied by UE 205. For example, network entity 210 may configure a SI, RRC, MAC CE, and/or DCI to convey an indication of the combining scheme to be used. Accordingly, in this eighth option UE 205 may receive an indication of the combining scheme to be applied when determining the second measurement result, which may be used to determine the combined measurement result indicated in the measurement report.

In some aspects, UE 205 may identify or otherwise determine that the measurement configuration(s) for the target BWP measurement configuration(s) is different from the measurement configuration(s) for the source BWP measurement configuration(s). In this situation, UE 205 may discard the last measurement samples (e.g., S_{source}) and the last measurement result (e.g., M_{source}) for the measurement quantity configured in the source BWP. Different measurement configurations in this context may include, but are not limited to, a cell identifier of a neighbor cell changing after BWP switching, the measurement quantities for the serving and/or neighbor cells being removed or added after BWP switching, or other configurations. In the situation where the downlink reference signal type is not specified or the downlink reference signal resource configuration is not available for the measurement quantity configured for the target BWP, UE 205 may send a UE assistance information and/or scheduling request requesting information for the downlink reference signal to be used in the target BWP after BWP switching.

In some examples, the measurement configuration(s) and/or measurement reporting configuration(s) may change after BWP switching (e.g., may be different in the second set of measurement configurations than in the first set of measurement configurations). In this situation, an interruption time may be defined for UE 205 to report the combined measurement report. That is and based on determining that the change in measurement configuration(s) from the first set to the second set and/or reporting configuration(s) changing in the measurement configuration(s) from the first set to the second set after BWP switching, UE 205 may identify or otherwise determine a change of measurement gap configurations for the serving or neighbor cell during BWP switching. UE 205 may also identify, based at least in part on the determine change(s), a timing gap threshold (e.g., the interruption time) for reporting the first measurement result in the second subband.

In some aspects, the interruption time may be based on various factors. That is, the interruption time may be based on the UE capability, the triggering events for the BWP switching, the radio access technology (RAT) type, the frequency range, the measurement type (intra-frequency, inter-frequency, or inter-RAT), the measurement gap, quality of service (QoS) requirements such as latency, reliability, or availability, as well as the service type. In the context of measurements and reporting the interruption time may be defined based on the trigger events of the active downlink BWP switching. Examples of the BWP switching trigger events include, but are not limited to, expiration of a BWP inactivity timer, RRC (re)configuration, receiving a DCI indicating active BWP switching, a RA procedure, acquisition of a modified SI outside of the active BWP, constant (e.g., a threshold amount) of CCA failures on a shared spectrum, a change in the duplex mode (e.g., between full and half duplex), the measurement gap, uplink carrier BWP switching, TCI state and/or transmit antenna switching, a power/energy saving status of UE 205 or the network, or other events. Accordingly, UE 205 may identify or otherwise determine the triggering event for the BWP switching and determine the timing gap threshold based on the trigger event.

Accordingly, UE 205 may identify, select, or otherwise determine the combining scheme to be applied when communicating the combined measurement result in the measurement report on the second subband after BWP switching.

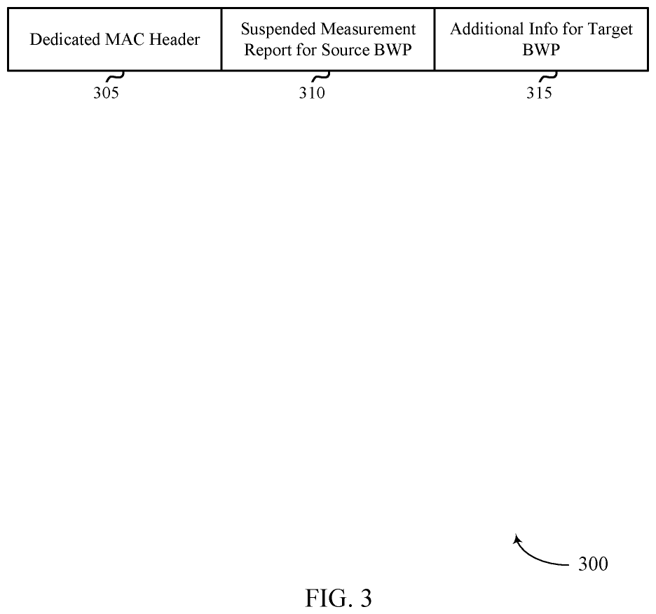

FIG. 3 illustrates an example of a message configuration 300 that supports channel measurements and reporting procedures associated with BWP switching in accordance with one or more aspects of the present disclosure. Aspects of message configuration 300 may be implemented by wireless communication systems 100 and/or 200. Aspects of message configuration 300 may be implemented at or implemented by a UE or network entity, which may be examples of the corresponding devices described herein.

As discussed above, aspects of the techniques described herein provide various mechanisms where a post-BWP switch UE may signal a combined measurement result in a measurement report on the target BWP (e.g., the new source BWP) after BWP switching. The combined measurement report may be based on first measurement results (e.g. M_{source}) for the original source BWP and/or second measurement results (e.g., M_{target}). For example, the UE may perform measurements on the first subband (e.g., the original source subband) to obtain the first measurement results and measurement results, after BWP switching, on the second subband (e.g., the new source subband) to obtain the second measurement result. The UE may use a first set of measurement configurations for the first measurements and a second set of measurement configurations for the second measurements. While the measurement configurations for the source and target subband may be different, they may share a common or different measurement filtering configuration for the measurement results. The UE may also identify or otherwise determine that the measurement gap configurations have changed after BWP switching. Accordingly, the UE may transmit or otherwise provide a measurement report on the second subband indicating the combined measurement results. In some examples, the combined measurement result may optionally be further based on the trigger event for the BWP switching, the UE capability, the change of measurement gap configurations for measurements and reporting by the UE after BWP switching, or other events.

In some examples, the measurement and reporting interval for the first set of measurement configurations (e.g., the measurement configurations configured for the first subband) may overlap in the time domain, at least to some degree, with the BWP switching. In this situation where the UE's measurement report interval in the source BWP at least partially overlaps with the BWP switching delay, various options may be considered for sending the first measurement result in the second subband after BWP switching to the target BWP. In some aspects, each option may be based on the UE identifying or otherwise determining that the measurement and reporting interval of the first set of measurement configurations overlaps with the BWP switching. For each option, the UE may generally suspend measurement and reporting for the serving and/or neighbor cell during the BWP switching.

A first option may include the UE transmitting or otherwise providing a set of UE assistance information messages or scheduling request messages requesting transmission of the first measurement result in the second subband (e.g., after BWP switching). That is, the UE may send scheduling request(s) or UE assistance information message(s) to the network to request (re)transmission of the suspended report (e.g., the measurement report for the first measurement results) in the target BWP. In some examples, this request may be combined with the UE's scheduling request or UE assistance information messages requesting the downlink reference signal source configurations (e.g., as discussed above with respect to FIG. 2). The request may be based on the overlap in the time domain.

A second option may include the UE multiplexing the first measurement result with additional uplink information in a message transmitted in the second subband. That is, the UE may multiplex the first measurement results in the suspended report with data/control/other measurement reports (e.g., the additional uplink information) transmitted by the UE in the target BWP after BWP switching. Message configuration 300 of FIG. 3 illustrates a non-limiting example of this second option where the suspended report may be appended with a dedicated MAC header. That is, the message may include a dedicated MAC header 305 used to convey relevant MAC information between the MAC protocol layer stacks within the network. The UE may append the suspended measurement report 310 (e.g., indicating the first measurement result) to the MAC header. The message may also include additional uplink information, such as additional information for the target BPW 315.

A third option may include the UE reprocessing the results in the suspended report using one of the options discussed with respect to FIG. 2, such as when the suspended measurement report is for a common measurement quantity configured for both the source BWP and the target BWP. Accordingly, the UE may measure the first set of measurement samples (e.g., S_{source}) for the serving and/or neighbor cell using the set of weighting factors discussed above, in some examples, to obtain an updated first measurement results. The combined measurement result indicated in the measurement report signaled in the second subband (e.g., the target BWP) may be based on the updated first measurement result.

A fourth option may include the UE comparing the timing gap between the first measurement result suspended during BWP switching and the second measurement result to a timing gap threshold. For example, the UE may compare D_{source,target}, the timing gap between the reporting time originally configured for the suspended report R_{source} and the reporting time configured for the latest report R_{target}. The UE may compare the timing gap with a threshold/timer D_{gap}. The UE may select or otherwise proceed with option 2 or option 3 (discussed above with reference to FIG. 3) if D_{source,target}≤D_{gap}. Otherwise, the UE may discard the report suspended in the source BWP. The combined measurement result indicated in the measurement report may be based on the result of the comparing.

A fifth option may include the UE selecting between options one and two above based on a (pre)configured validation criteria or the resource size available for reporting measurement result in the target BWP. That is, the UE may transmit scheduling request and/or UE assistance information messages requesting transmission of the suspended report (option 1) or multiplex the suspended report with other uplink data (option 2) based on the reporting resource size of the target BWP (e.g., based on the second set of measurement configuration(s) of the second subband) and/or the timing gap threshold between the first and second measurement results.

A sixth option may include the UE selecting between options one-to-four based on the UE capabilities, the measurement priority of the first measurement result, available UE power headroom, the measurement gap configuration of the second measurement result, the reporting configuration for the second measurement result, or other information.

A seventy option may be based on UE implementation where the UE autonomously selects the transmission scheme for reporting the first measurement results in the second subband.

An eighth option may be based on the network explicitly/implicitly signaling which option above that the UE will use for reporting the first measurement result in the second subband after BWP switching. Accordingly, the UE may receive or otherwise obtain an indication of the transmission scheme to be used for reporting the first measurement result in the second subband after BWP switching. The UE may use the transmission scheme (e.g., one of the options discussed above) when transmitting the first measurement result.

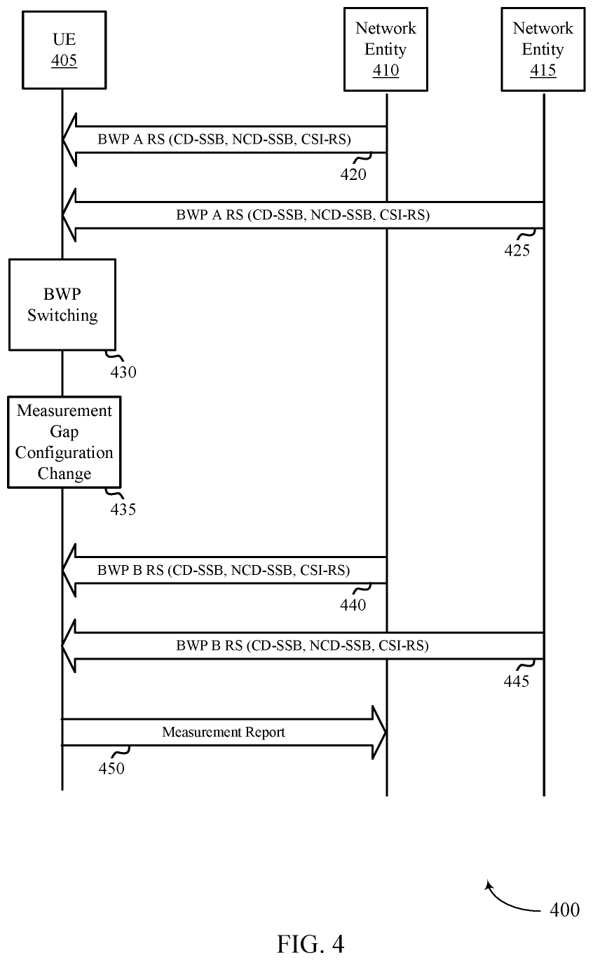

FIG. 4 illustrates an example of a method 400 that supports channel measurements and reporting procedures associated with BWP switching in accordance with one or more aspects of the present disclosure. Method 400 may implement aspects of wireless communications systems 100 and/or 200 and/or aspects of message configuration 300. Aspects of method 400 may be implemented at or implemented by a UE 405, network entity 410, and/or network entity 415, which may be examples of the corresponding devices described herein. In some examples, network entity 410 may be an example of a serving cell of UE 405 and network entity 415 may be an example of a neighbor cell of UE 405.

At 420, UE 405 may be performing a first measurement of a serving cell in a first subband of a bandwidth using a first set of measurement configurations to obtain a first measurement result. At 425, UE 405 may be performing a first measurement of a neighbor cell in the first subband of the bandwidth using the first set of measurement configurations to obtain the first measurement result. That is, the UE may perform the first measurement on the serving cell at 420 or the neighbor cell at 425 using the first set of measurement configurations to identify or otherwise obtain the first measurement result. It is to be understood that the first measurement may be performed on the serving cell or the neighbor cell in some examples.

At 430, UE 405 may perform BWP switching from the first subband (e.g., the source BWP) to a second subband (e.g., a target BWP). The BWP switching may be initiated by a number of different trigger events as discussed with reference to FIG. 2 and/or FIG. 3.

At 435, UE 405 may identify or otherwise determine a change in the measurement gap configurations for the serving cell or the neighbor cell associated with the BWP switching. That is, the measurement gap configuration in the second set of measurement configurations for the second subband may be different than the measurement gap configuration in the first set of measurement configurations for the first subband. Accordingly, the measurement gap configuration being used for measurements and reporting may change due to the BWP switching.

At 440, UE 405 may be performing a second measurement of a serving cell in a second subband of a bandwidth using a second set of measurement configurations to obtain a second measurement result. At 445, UE 405 may be performing a second measurement of a neighbor cell in the second subband of the bandwidth using the second set of measurement configurations to obtain the second measurement result. That is, the UE may perform the second measurement on the serving cell at 440 or the neighbor cell at 445 using the second set of measurement configurations to identify or otherwise obtain the second measurement result. It is to be understood that the second measurement may be performed on the serving cell or the neighbor cell in some examples.

As discussed above, the first measurement on the first subband pre-BWP switching and/or second measurement on the second subband post-BWP switching may be based on measurement samples (e.g., S_{source}, S_{target}) For example, UE 405 may perform the measurements to obtain the L1 measurement samples and then apply a common filtering configuration at L3 to obtain the measurement results.

At 450, UE 405 may transmit or otherwise provide a measurement report indicating a combined measurement result. The combined measurement result may be based on the first measurement result and/or the second measurement result. The combined measurement result may be further based on, in some example, the trigger event for the BWP switching, or the UE capability.

Accordingly, UE 405 may be configured to maintain measurement and reporting procedures during BWP switching between different subbands within the bandwidth.

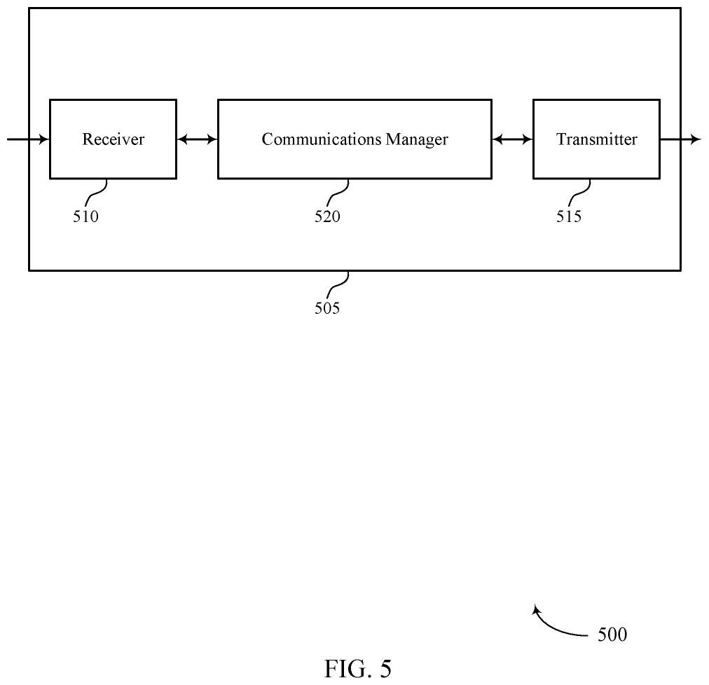

FIG. 5 shows a block diagram 500 of a device 505 that supports channel measurements and reporting procedures associated with BWP switching in accordance with one or more aspects of the present disclosure. The device 505 may be an example of aspects of a UE 115 as described herein. The device 505 may include a receiver 510, a transmitter 515, and a communications manager 520. The device 505 may also include at least one processor (e.g., one or more processors). Each of these components may be in communication with one another (e.g., via one or more buses).

The receiver 510 may provide a means for receiving information such as packets, user data, control information, or any combination thereof associated with various information channels (e.g., control channels, data channels, information channels related to channel measurements and reporting procedures associated with BWP switching). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to channel measurements and reporting procedures associated with BWP switching). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of channel measurements and reporting procedures associated with BWP switching as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include at least one processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor (or processors) and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for performing a first measurement for a serving cell or a neighbor cell in a first subband of a bandwidth using a first set of measurement configurations to obtain a first measurement result. The communications manager 520 may be configured as or otherwise support a means for performing BWP switching from the first subband to a second subband of the bandwidth. The communications manager 520 may be configured as or otherwise support a means for identifying a change of measurement gap configurations for the serving cell or the neighbor cell associated with the BWP switching. The communications manager 520 may be configured as or otherwise support a means for performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The communications manager 520 may be configured as or otherwise support a means for transmitting a measurement report indicating a combined measurement result that is based on the first measurement result, the second measurement result, a trigger event for the BWP switching, a UE capability, the change of measurement gap configurations associated with the BWP switching, or a combination thereof.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for improved channel performance measurement and reporting procedures when the UE performs BWP switching from a source BWP to a target BWP.

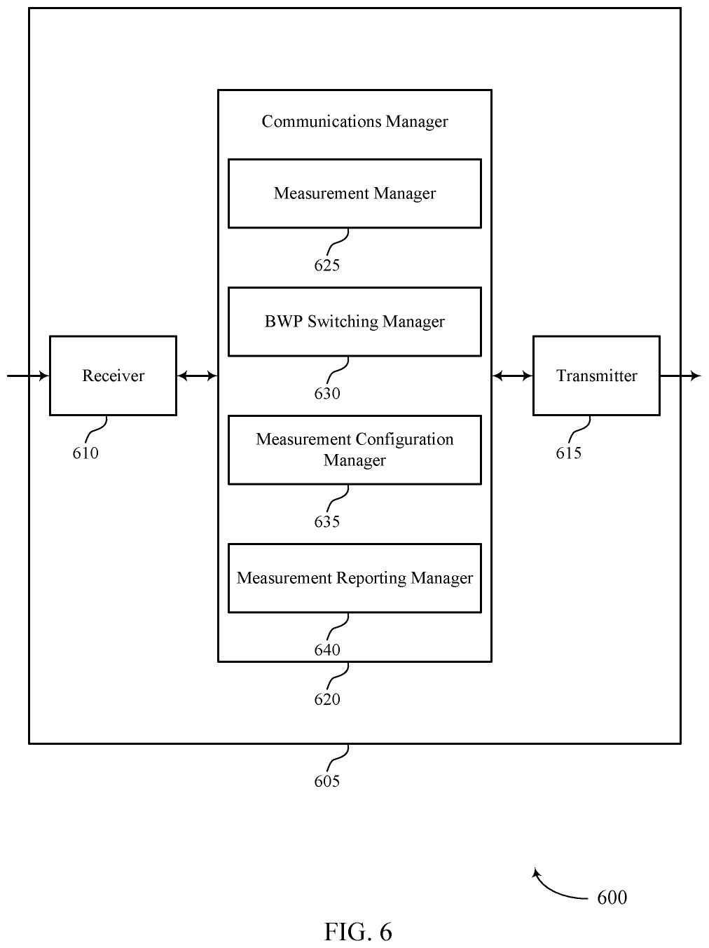

FIG. 6 shows a block diagram 600 of a device 605 that supports channel measurements and reporting procedures associated with BWP switching in accordance with one or more aspects of the present disclosure. The device 605 may be an example of aspects of a device 505 or a UE 115 as described herein. The device 605 may include a receiver 610, a transmitter 615, and a communications manager 620. The device 605 may also include at least one processor. Each of these components may be in communication with one another (e.g., via one or more buses).

The receiver 610 may provide a means for receiving information such as packets, user data, control information, or any combination thereof associated with various information channels (e.g., control channels, data channels, information channels related to channel measurements and reporting procedures associated with BWP switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel measurements and reporting procedures associated with BWP switching). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of channel measurements and reporting procedures associated with BWP switching as described herein. For example, the communications manager 620 may include a measurement manager 625, a BWP switching manager 630, a measurement configuration manager 635, a measurement reporting manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The measurement manager 625 may be configured as or otherwise support a means for performing a first measurement for a serving cell or a neighbor cell in a first subband of a bandwidth using a first set of measurement configurations to obtain a first measurement result. The BWP switching manager 630 may be configured as or otherwise support a means for performing BWP switching from the first subband to a second subband of the bandwidth. The measurement configuration manager 635 may be configured as or otherwise support a means for identifying a change of measurement gap configurations for the serving cell or the neighbor cell associated with the BWP switching. The measurement manager 625 may be configured as or otherwise support a means for performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The measurement reporting manager 640 may be configured as or otherwise support a means for transmitting a measurement report indicating a combined measurement result that is based on the first measurement result, the second measurement result, a trigger event for the BWP switching, a UE capability, the change of measurement gap configurations associated with the BWP switching, or a combination thereof.

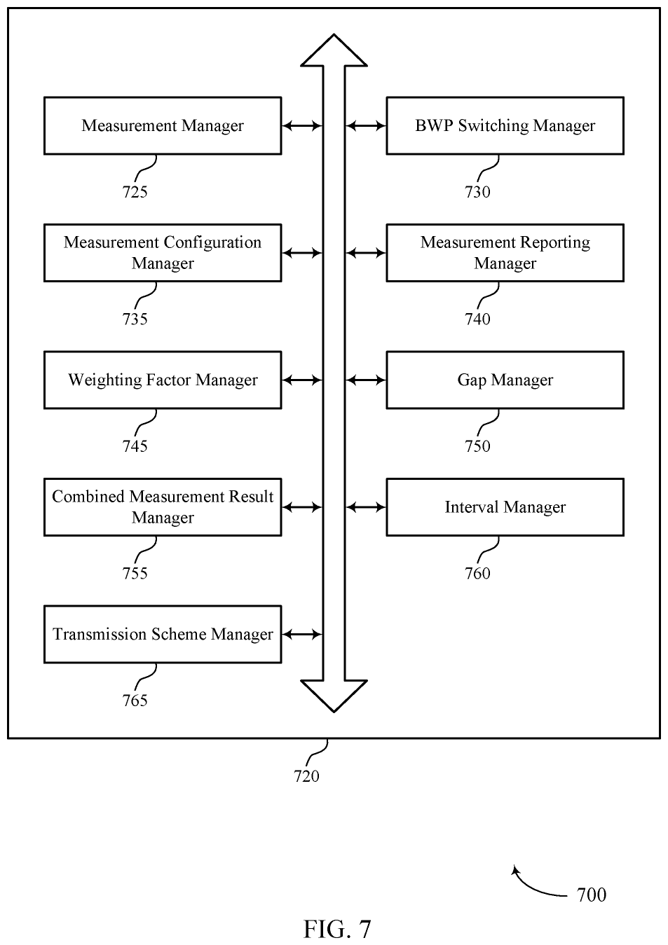

FIG. 7 shows a block diagram 700 of a communications manager 720 that supports channel measurements and reporting procedures associated with BWP switching in accordance with one or more aspects of the present disclosure. The communications manager 720 may be an example of aspects of a communications manager 520, a communications manager 620, or both, as described herein. The communications manager 720, or various components thereof, may be an example of means for performing various aspects of channel measurements and reporting procedures associated with BWP switching as described herein. For example, the communications manager 720 may include a measurement manager 725, a BWP switching manager 730, a measurement configuration manager 735, a measurement reporting manager 740, a weighting factor manager 745, a gap manager 750, a combined measurement result manager 755, an interval manager 760, a transmission scheme manager 765, or any combination thereof. Each of these components may communicate, directly or indirectly, with one another (e.g., via one or more buses).

The communications manager 720 may support wireless communication at a UE in accordance with examples as disclosed herein. The measurement manager 725 may be configured as or otherwise support a means for performing a first measurement for a serving cell or a neighbor cell in a first subband of a bandwidth using a first set of measurement configurations to obtain a first measurement result. The BWP switching manager 730 may be configured as or otherwise support a means for performing BWP switching from the first subband to a second subband of the bandwidth. The measurement configuration manager 735 may be configured as or otherwise support a means for identifying a change of measurement gap configurations for the serving cell or the neighbor cell associated with the BWP switching. In some examples, the measurement manager 725 may be configured as or otherwise support a means for performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The measurement reporting manager 740 may be configured as or otherwise support a means for transmitting a measurement report indicating a combined measurement result that is based on the first measurement result, the second measurement result, a trigger event for the BWP switching, a UE capability, the change of measurement gap configurations associated with the BWP switching, or a combination thereof.

In some examples, the weighting factor manager 745 may be configured as or otherwise support a means for identifying a set of weighting factors associated with the first subband and the second subband. In some examples, the weighting factor manager 745 may be configured as or otherwise support a means for combining the first measurement result with a set of measurement samples associated with the second measurement result using the set of weighting factors to obtain the second measurement result, where the measurements and combining are performed for the serving cell or the neighbor cell.

In some examples, the weighting factor manager 745 may be configured as or otherwise support a means for identifying a set of weighting factors for measurements associated with the first subband and the second subband. In some examples, the weighting factor manager 745 may be configured as or otherwise support a means for combining a first set of measurement samples associated with the first measurement result and the first measurement result with a second set of measurement samples associated with the second measurement result using the set of weighting factors to obtain the second measurement result, where the measurements and combining are performed for the serving cell or the neighbor cell.

In some examples, the weighting factor manager 745 may be configured as or otherwise support a means for comparing a first set of measurement samples associated with the first measurement result to a measurement threshold. In some examples, the weighting factor manager 745 may be configured as or otherwise support a means for identifying a set of weighting factors associated with the first subband and the second subband. In some examples, the weighting factor manager 745 may be configured as or otherwise support a means for combining, based on a result of the comparing, the first set of measurement samples, the first measurement result, a second set of measurement samples associated with the second measurement result, or a combination thereof, using the set of weighting factors to obtain the second measurement result. In some examples, the first set of measurement samples and the second set of measurement samples include physical layer measurements and/or RRC layer measurements used to determine one or more measurement results for the serving cell or the neighbor cell, which may be used for procedures including mobility management, beam management, positioning, radio link monitoring, power control, timing control, time alignment timer validation, radio resource selection, ranging, sensing and speed estimation.

In some examples, the gap manager 750 may be configured as or otherwise support a means for comparing a time gap between measuring a first set of measurement samples associated with the first measurement result and measuring a second set of measurement samples associated with the second measurement result to a gap threshold. In some examples, the gap manager 750 may be configured as or otherwise support a means for identifying a set of weighting factors associated with the first subband and the second subband. In some examples, the gap manager 750 may be configured as or otherwise support a means for combining, based on a result of the comparing, the first set of measurement samples, the first measurement result, a second set of measurement samples associated with the second measurement result, or a combination thereof, using the set of weighting factors to obtain the second measurement result, where the measurements and combining are performed for the serving cell and the neighbor cell.

In some examples, the combined measurement result manager 755 may be configured as or otherwise support a means for combining, based on a measurement threshold, a gap threshold, or a combination thereof, a first set of measurement samples associated with the first measurement result, the first measurement result, a second set of measurement samples associated with the second measurement result, or a combination thereof, using a set of weighting factors to obtain the second measurement result, where the measurements and combining are performed for the serving cell and the neighbor cell.

In some examples, the combined measurement result manager 755 may be configured as or otherwise support a means for combining, based on a UE capability, a measurement priority, an available UE power headroom, or a combination thereof, a first set of measurement samples associated with the first measurement result, the first measurement result, a second set of measurement samples associated with the second measurement result, or a combination thereof, to obtain the second measurement result for the serving cell or the neighbor cell.

In some examples, the combined measurement result manager 755 may be configured as or otherwise support a means for combining a first set of measurement samples associated with the first measurement result, the first measurement result, a second set of measurement samples associated with the second measurement result, or a combination thereof, to obtain the second measurement result for the serving cell or the neighbor cell.

In some examples, the combined measurement result manager 755 may be configured as or otherwise support a means for receiving an indication of a combining scheme for combining a first set of measurement samples associated with the first measurement result, the first measurement result, a second set of measurement samples associated with the second measurement result, or a combination thereof, to obtain the second measurement result for the serving cell or the neighbor cell.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending measurement and reporting for the serving cell and the neighbor cell during the BWP switching. In some examples, the interval manager 760 may be configured as or otherwise support a means for transmitting, after the BWP switching and based on the overlap, a set of UE assistance information messages or scheduling request messages requesting transmission of the first measurement result in the second subband.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending measurement and reporting for the serving cell and the neighbor cell during BWP. In some examples, the interval manager 760 may be configured as or otherwise support a means for multiplexing, after the BWP switching and based on the overlap, the first measurement result and additional uplink information in a message transmitted in the second subband. In some examples, the first measurement result is indicated in a MAC header of the message.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending the measurement and reporting for the serving cell and the neighbor cell during BWP switching. In some examples, the interval manager 760 may be configured as or otherwise support a means for measuring, after the BWP switching and based on the overlap, a first set of measurement samples for the serving cell or the neighbor cell using a set of weighting factors to obtain an updated first measurement result, where the combined measurement result is based on the updated first measurement result.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending measurement and reporting for the serving cell and the neighbor cell during BWP switching. In some examples, the interval manager 760 may be configured as or otherwise support a means for comparing, after the BWP switching and based on the overlap, a timing gap between the first measurement result suspended during BWP switching and the second measurement result to a timing gap threshold, where combined measurement result is based on a result of the comparing.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending measurement and reporting for the serving cell and the neighbor cell during BWP switching. In some examples, the interval manager 760 may be configured as or otherwise support a means for transmitting, after the BWP switching and based on the overlap, a message requesting transmission of the first measurement result suspended during BWP switching or a message where the first measurement result suspended during BWP switching is multiplexed with additional uplink information based on a reporting resource size of the second set of measurement configurations, a timing gap threshold between the first measurement result and the second measurement result, or a combination thereof.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending measurement and reporting for the serving cell and the neighbor cell during BWP switching. In some examples, the interval manager 760 may be configured as or otherwise support a means for selecting, after the BWP switching and based on the overlap, a transmission scheme for reporting the first measurement result based on a UE capability, a measurement priority of the first measurement result, an available UE power headroom, a measurement gap configuration for the second measurement result, a reporting configuration for the second measurement result, or a combination thereof.

In some examples, the interval manager 760 may be configured as or otherwise support a means for determining that a measurement and reporting interval of the first set of measurement configurations overlaps with the BWP switching. In some examples, the interval manager 760 may be configured as or otherwise support a means for suspending measurement and reporting for the serving cell and the neighbor cell during BWP switching. In some examples, the interval manager 760 may be configured as or otherwise support a means for autonomously selecting, after the BWP switching and based on the overlap, a transmission scheme for reporting the first measurement result.

In some examples, the transmission scheme manager 765 may be configured as or otherwise support a means for receiving an indication of a transmission scheme for reporting the first measurement result in the second subband. In some examples, the transmission scheme manager 765 may be configured as or otherwise support a means for determining that a measurement and reporting interval of the first set of measurement configurations overlaps with the BWP switching. In some examples, the transmission scheme manager 765 may be configured as or otherwise support a means for suspending measurement and reporting for the serving cell and the neighbor cell during BWP switching. In some examples, the transmission scheme manager 765 may be configured as or otherwise support a means for transmitting, after the BWP switching and based on the overlap, the first measurement result according to the transmission scheme.

In some examples, the measurement configuration manager 735 may be configured as or otherwise support a means for determining that the first set of measurement configurations is different from the second set of measurement configurations, that a first reporting configuration of the first set of measurement configurations is different from a second reporting configuration of the second set of measurement configurations, or both, and a change of measurement gap configurations for the serving cell or the neighbor cell during BWP switching. In some examples, the measurement configuration manager 735 may be configured as or otherwise support a means for identifying, based on the determining, a timing gap threshold for reporting the first measurement result in the second subband.

In some examples, the measurement configuration manager 735 may be configured as or otherwise support a means for identifying a triggering event triggering the BWP switching, where the timing gap threshold is based on a timing of the triggering event, a type of the trigger event, a UE capability, the measurement gap configurations for the second measurement of the serving cell or the neighbor cell.

In some examples, the change of measurement gap configurations include a change of a reference signal type, a reference signal resource configuration, a gap configuration, a length of measurements, a number of intra-frequency measurements, a number of inter-frequency measurements, a window configuration, a measurement periodicity, a measurement offset time, a reporting condition, a priority level, or a combination thereof, for the measurement and reporting for the serving cell and the neighbor cell.

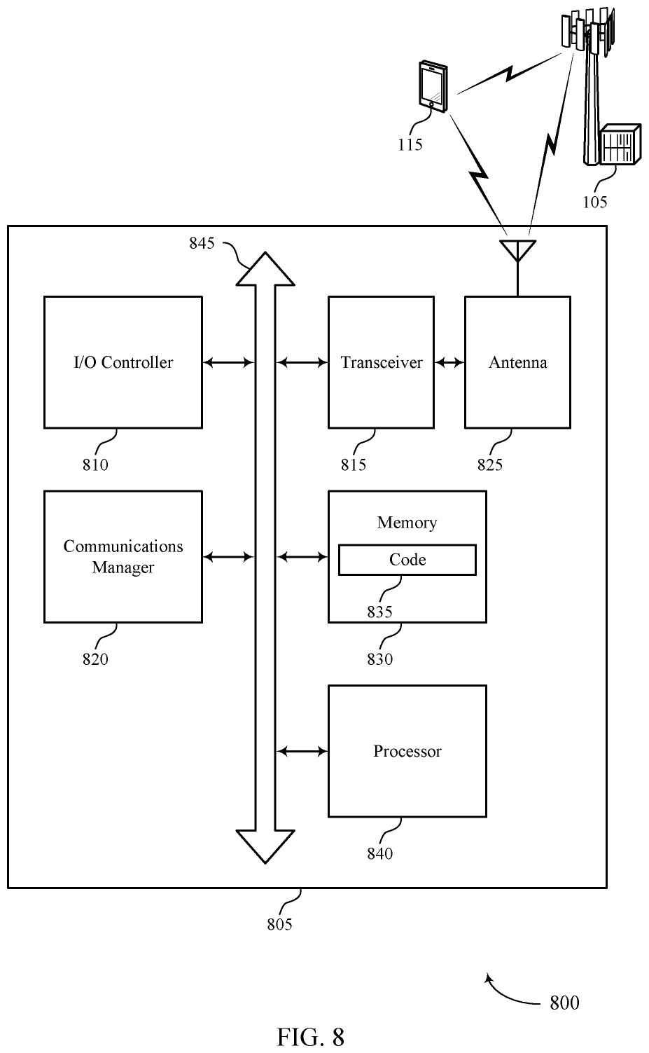

FIG. 8 shows a diagram of a system 800 including a device 805 that supports channel measurements and reporting procedures associated with BWP switching in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor(s), a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting channel measurements and reporting procedures associated with BWP switching). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for performing a first measurement for a serving cell or a neighbor cell in a first subband of a bandwidth using a first set of measurement configurations to obtain a first measurement result. The communications manager 820 may be configured as or otherwise support a means for performing BWP switching from the first subband to a second subband of the bandwidth. The communications manager 820 may be configured as or otherwise support a means for identifying a change of measurement gap configurations for the serving cell or the neighbor cell associated with the BWP switching. The communications manager 820 may be configured as or otherwise support a means for performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The communications manager 820 may be configured as or otherwise support a means for transmitting a measurement report indicating a combined measurement result that is based on the first measurement result, the second measurement result, a trigger event for the BWP switching, a UE capability, the change of measurement gap configurations associated with the BWP switching, or a combination thereof.

By including or configuring the communications manager 820 in accordance with examples as described herein, the device 805 may support techniques for improved channel performance measurement and reporting procedures when the UE performs BWP switching from a source BWP to a target BWP.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 (e.g., directly, indirectly, after pre-processing, without pre-processing) to cause the device 805 to perform various aspects of channel measurements and reporting procedures associated with BWP switching as described herein, or the processor 840 and the memory 830 may be otherwise configured to perform or support such operations.

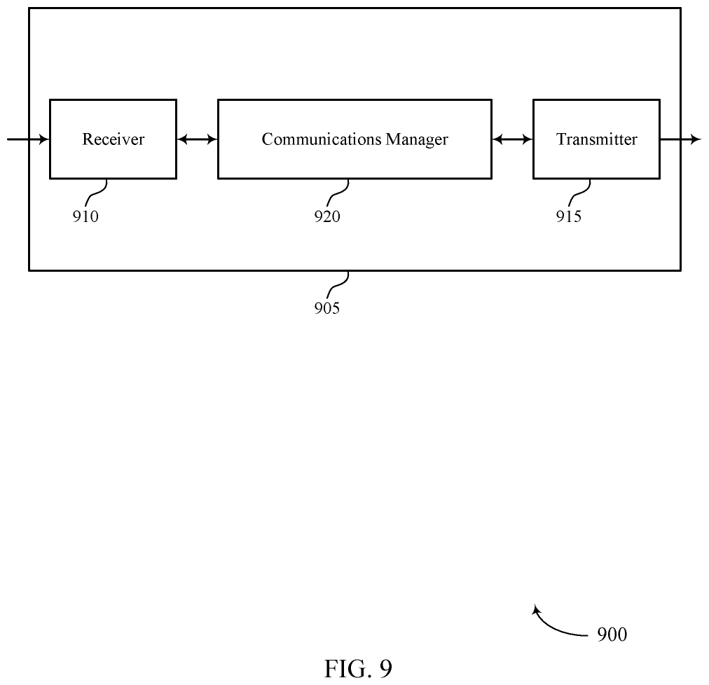

FIG. 9 shows a block diagram 900 of a device 905 that supports channel measurements and reporting procedures associated with BWP switching in accordance with one or more aspects of the present disclosure. The device 905 may be an example of aspects of a network entity 105 as described herein. The device 905 may include a receiver 910, a transmitter 915, and a communications manager 920. The device 905 may also include at least one processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of channel measurements and reporting procedures associated with BWP switching as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the at least one processor, instructions stored in the memory).

Additionally, or alternatively, in some examples, the communications manager 920, the receiver 910, the transmitter 915, or various combinations or components thereof may be implemented in code (e.g., as communications management software) executed by at least one processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting, to a UE, an indication of a first set of measurement configurations for a first subband of a bandwidth and a second set of measurement configurations for a second subband of the bandwidth. The communications manager 920 may be configured as or otherwise support a means for determining that the UE has performed a BWP switching from the first subband to the second subband. The communications manager 920 may be configured as or otherwise support a means for receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for improved channel performance measurement and reporting procedures when the UE performs BWP switching from a source BWP to a target BWP.

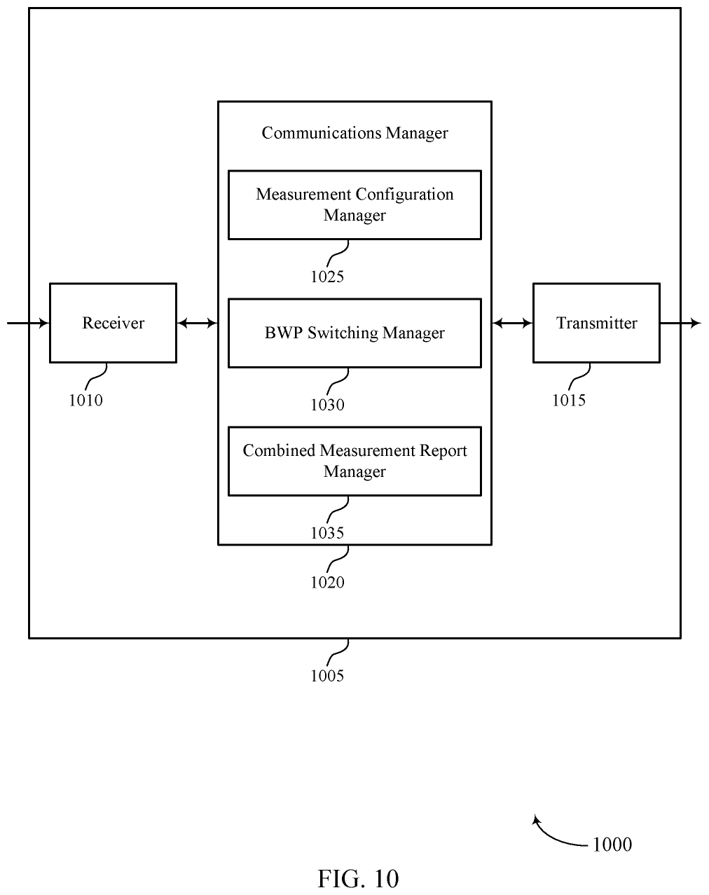

FIG. 10 shows a block diagram 1000 of a device 1005 that supports channel measurements and reporting procedures associated with BWP switching in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include at least one processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of channel measurements and reporting procedures associated with BWP switching as described herein. For example, the communications manager 1020 may include a measurement configuration manager 1025, a BWP switching manager 1030, a combined measurement report manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The measurement configuration manager 1025 may be configured as or otherwise support a means for transmitting, to a UE, an indication of a first set of measurement configurations for a first subband of a bandwidth and a second set of measurement configurations for a second subband of the bandwidth. The BWP switching manager 1030 may be configured as or otherwise support a means for determining that the UE has performed a BWP switching from the first subband to the second subband. The combined measurement report manager 1035 may be configured as or otherwise support a means for receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

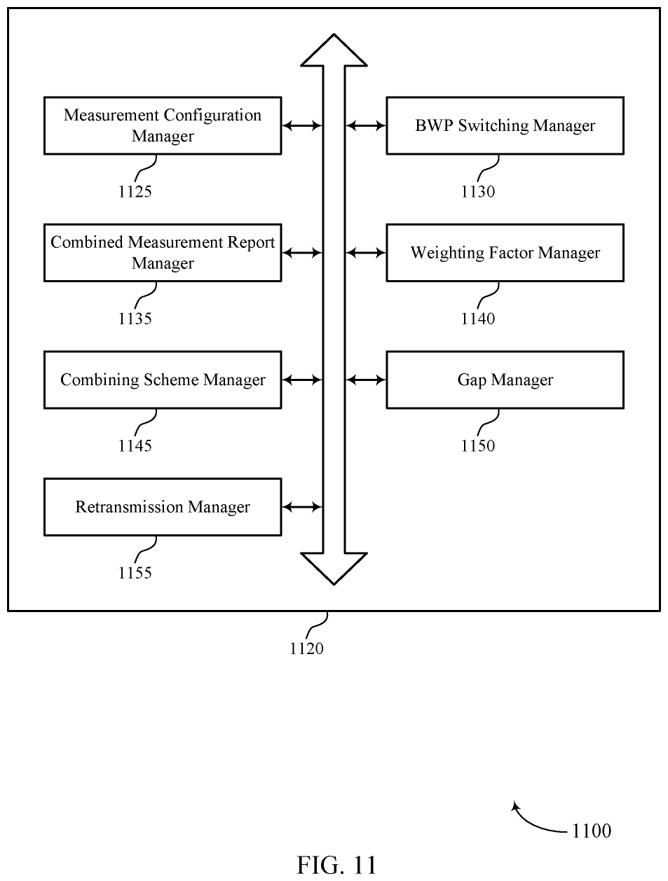

FIG. 11 shows a block diagram 1100 of a communications manager 1120 that supports channel measurements and reporting procedures associated with BWP switching in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of channel measurements and reporting procedures associated with BWP switching as described herein. For example, the communications manager 1120 may include a measurement configuration manager 1125, a BWP switching manager 1130, a combined measurement report manager 1135, a weighting factor manager 1140, a combining scheme manager 1145, a gap manager 1150, a retransmission manager 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The measurement configuration manager 1125 may be configured as or otherwise support a means for transmitting, to a UE, an indication of a first set of measurement configurations for a first subband of a bandwidth and a second set of measurement configurations for a second subband of the bandwidth. The BWP switching manager 1130 may be configured as or otherwise support a means for determining that the UE has performed a BWP switching from the first subband to the second subband. The combined measurement report manager 1135 may be configured as or otherwise support a means for receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

In some examples, the weighting factor manager 1140 may be configured as or otherwise support a means for transmitting an indication of a set of weighting factors associated with the first subband and the second subband to the UE, where the combined measurement result is based on the set of weighting factors.

In some examples, the combining scheme manager 1145 may be configured as or otherwise support a means for transmitting an indication of a combining scheme for the UE to combine a first set of measurement samples associated with the first measurement result, the first measurement result, a second set of samples associated with the second measurement result, or a combination thereof, where the combined measurement result is based on the combining scheme.

In some examples, the gap manager 1150 may be configured as or otherwise support a means for transmitting an indication of a timing gap threshold for a timing gap between the first measurement result and the second measurement result, where the combined measurement result is based on the timing gap threshold.

In some examples, the retransmission manager 1155 may be configured as or otherwise support a means for receiving a message from the UE requesting transmission of the first measurement result in the second subband.

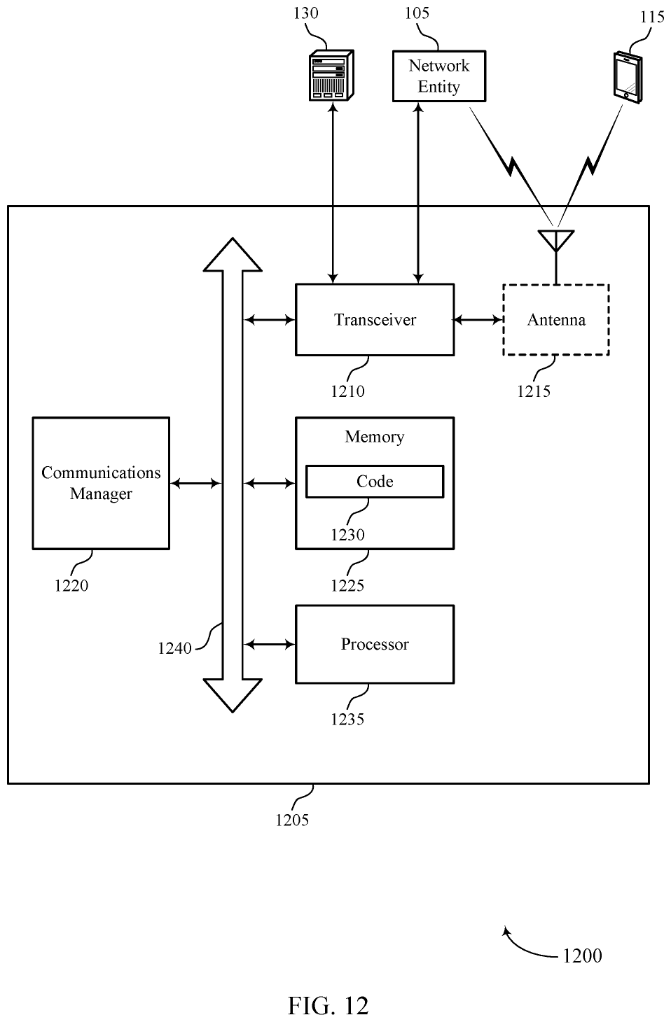

FIG. 12 shows a diagram of a system 1200 including a device 1205 that supports channel measurements and reporting procedures associated with BWP switching in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor(s), a DSP, an ASIC, a CPU, a GPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting channel measurements and reporting procedures associated with BWP switching). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1205 may transmit information output from the chip or modem. In some implementations, the second interface may refer to an interface between the processing system of the chip or modem and a receiver, such that the device 1205 may obtain information or signal inputs, and the information may be passed to the processing system. A person having ordinary skill in the art will readily recognize that the first interface also may obtain information or signal inputs, and the second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting, to a UE, an indication of a first set of measurement configurations for a first subband of a bandwidth and a second set of measurement configurations for a second subband of the bandwidth. The communications manager 1220 may be configured as or otherwise support a means for determining that the UE has performed a BWP switching from the first subband to the second subband. The communications manager 1220 may be configured as or otherwise support a means for receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof.

By including or configuring the communications manager 1220 in accordance with examples as described herein, the device 1205 may support techniques for improved channel performance measurement and reporting procedures when the UE performs BWP switching from a source BWP to a target BWP.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 (e.g., directly, indirectly, after pre-processing, without pre-processing) to cause the device 1205 to perform various aspects of channel measurements and reporting procedures associated with BWP switching as described herein, or the processor 1235 and the memory 1225 may be otherwise configured to perform or support such operations.

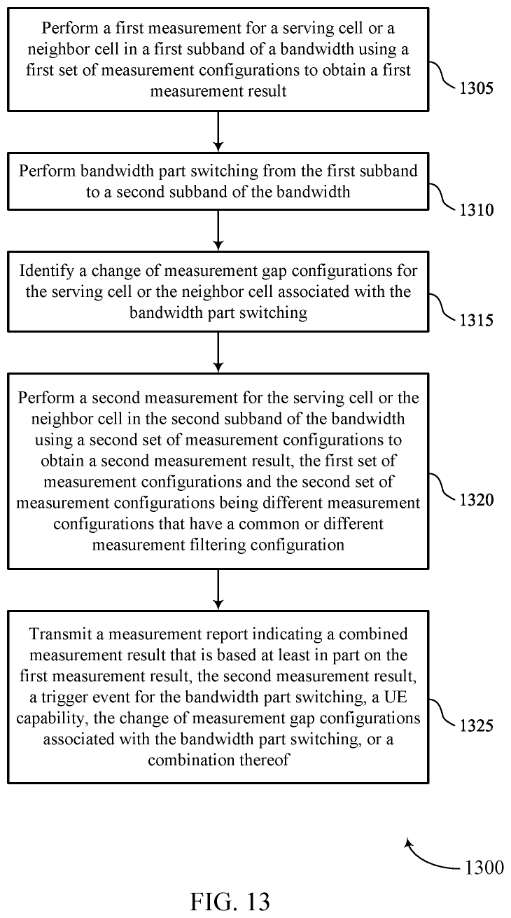

FIG. 13 shows a flowchart illustrating a method 1300 that supports channel measurements and reporting procedures associated with BWP switching in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include performing a first measurement for a serving cell or a neighbor cell in a first subband of a bandwidth using a first set of measurement configurations to obtain a first measurement result. The operations of 1305 may be performed in accordance with examples as disclosed herein. In some examples, aspects of the operations of 1305 may be performed by a measurement manager 725 as described with reference to FIG. 7.

At 1310, the method may include performing BWP switching from the first subband to a second subband of the bandwidth. The operations of 1310 may be performed in accordance with examples as disclosed herein. In some examples, aspects of the operations of 1310 may be performed by a BWP switching manager 730 as described with reference to FIG. 7.

At 1315, the method may include identifying a change of measurement gap configurations for the serving cell or the neighbor cell associated with the BWP switching. The operations of 1315 may be performed in accordance with examples as disclosed herein. In some examples, aspects of the operations of 1315 may be performed by a measurement configuration manager 735 as described with reference to FIG. 7.

At 1320, the method may include performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The operations of 1320 may be performed in accordance with examples as disclosed herein. In some examples, aspects of the operations of 1320 may be performed by a measurement manager 725 as described with reference to FIG. 7.

At 1325, the method may include transmitting a measurement report indicating a combined measurement result that is based on the first measurement result, the second measurement result, a trigger event for the BWP switching, a UE capability, the change of measurement gap configurations associated with the BWP switching, or a combination thereof. The operations of 1325 may be performed in accordance with examples as disclosed herein. In some examples, aspects of the operations of 1325 may be performed by a measurement reporting manager 740 as described with reference to FIG. 7.

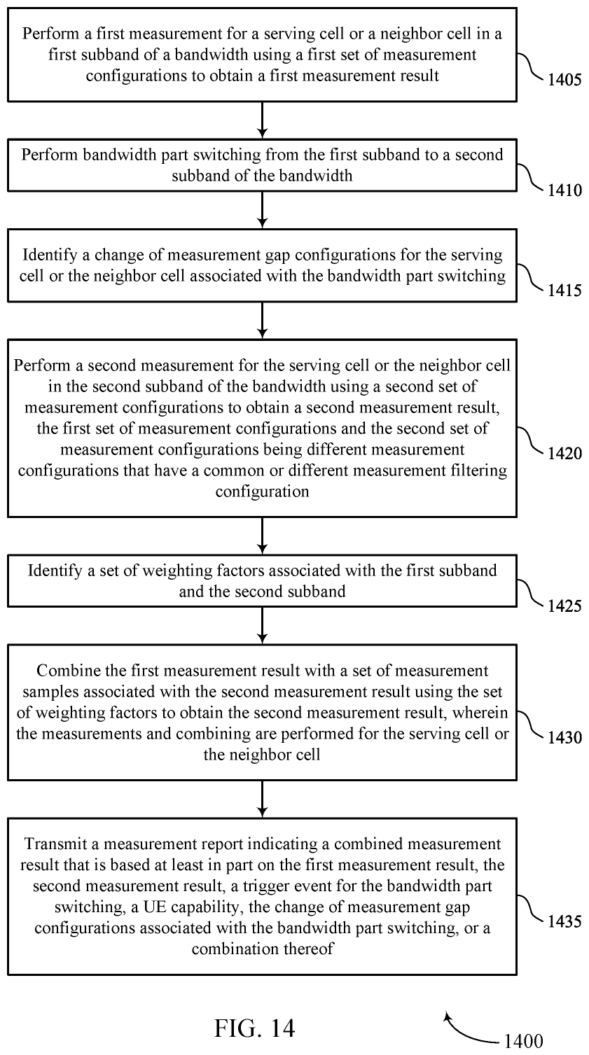

FIG. 14 shows a flowchart illustrating a method 1400 that supports channel measurements and reporting procedures associated with BWP switching in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include performing a first measurement for a serving cell or a neighbor cell in a first subband of a bandwidth using a first set of measurement configurations to obtain a first measurement result. The operations of 1405 may be performed in accordance with examples as disclosed herein. In some examples, aspects of the operations of 1405 may be performed by a measurement manager 725 as described with reference to FIG. 7.

At 1410, the method may include performing BWP switching from the first subband to a second subband of the bandwidth. The operations of 1410 may be performed in accordance with examples as disclosed herein. In some examples, aspects of the operations of 1410 may be performed by a BWP switching manager 730 as described with reference to FIG. 7.

At 1415, the method may include identifying a change of measurement gap configurations for the serving cell or the neighbor cell associated with the BWP switching. The operations of 1415 may be performed in accordance with examples as disclosed herein. In some examples, aspects of the operations of 1415 may be performed by a measurement configuration manager 735 as described with reference to FIG. 7.

At 1420, the method may include performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The operations of 1420 may be performed in accordance with examples as disclosed herein. In some examples, aspects of the operations of 1420 may be performed by a measurement manager 725 as described with reference to FIG. 7.

At 1425, the method may include identifying a set of weighting factors associated with the first subband and the second subband. The operations of 1425 may be performed in accordance with examples as disclosed herein. In some examples, aspects of the operations of 1425 may be performed by a weighting factor manager 745 as described with reference to FIG. 7.

At 1430, the method may include combining the first measurement result with a set of measurement samples associated with the second measurement result using the set of weighting factors to obtain the second measurement result, where the measurements and combining are performed for the serving cell or the neighbor cell. The operations of 1430 may be performed in accordance with examples as disclosed herein. In some examples, aspects of the operations of 1430 may be performed by a weighting factor manager 745 as described with reference to FIG. 7.

At 1435, the method may include transmitting a measurement report indicating a combined measurement result that is based on the first measurement result, the second measurement result, a trigger event for the BWP switching, a UE capability, the change of measurement gap configurations associated with the BWP switching, or a combination thereof. The operations of 1435 may be performed in accordance with examples as disclosed herein. In some examples, aspects of the operations of 1435 may be performed by a measurement reporting manager 740 as described with reference to FIG. 7.

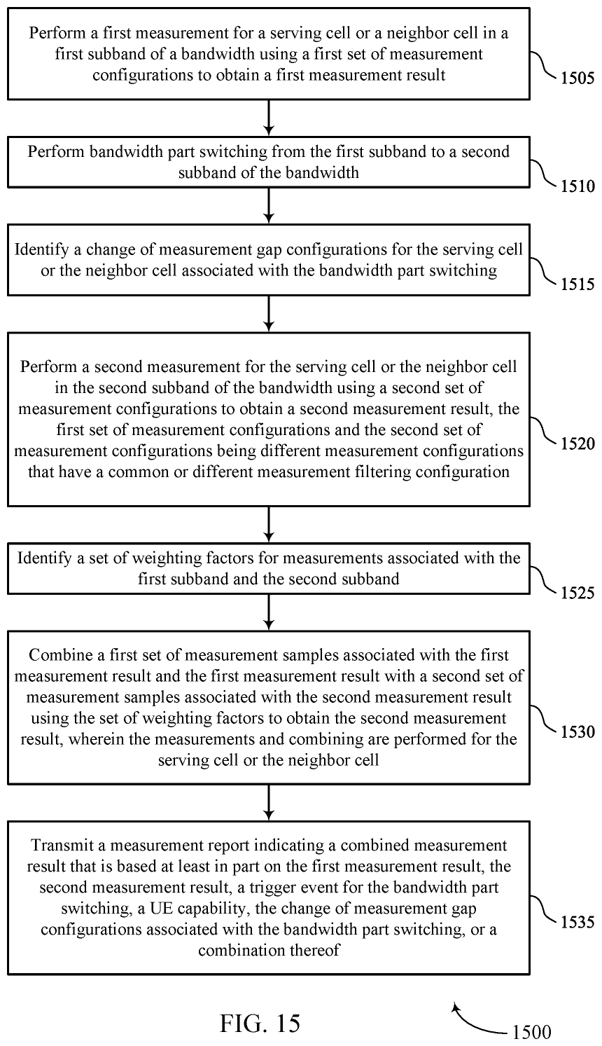

FIG. 15 shows a flowchart illustrating a method 1500 that supports channel measurements and reporting procedures associated with BWP switching in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include performing a first measurement for a serving cell or a neighbor cell in a first subband of a bandwidth using a first set of measurement configurations to obtain a first measurement result. The operations of 1505 may be performed in accordance with examples as disclosed herein. In some examples, aspects of the operations of 1505 may be performed by a measurement manager 725 as described with reference to FIG. 7.

At 1510, the method may include performing BWP switching from the first subband to a second subband of the bandwidth. The operations of 1510 may be performed in accordance with examples as disclosed herein. In some examples, aspects of the operations of 1510 may be performed by a BWP switching manager 730 as described with reference to FIG. 7.

At 1515, the method may include identifying a change of measurement gap configurations for the serving cell or the neighbor cell associated with the BWP switching. The operations of 1515 may be performed in accordance with examples as disclosed herein. In some examples, aspects of the operations of 1515 may be performed by a measurement configuration manager 735 as described with reference to FIG. 7.

At 1520, the method may include performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration. The operations of 1520 may be performed in accordance with examples as disclosed herein. In some examples, aspects of the operations of 1520 may be performed by a measurement manager 725 as described with reference to FIG. 7.

At 1525, the method may include identifying a set of weighting factors for measurements associated with the first subband and the second subband. The operations of 1525 may be performed in accordance with examples as disclosed herein. In some examples, aspects of the operations of 1525 may be performed by a weighting factor manager 745 as described with reference to FIG. 7.

At 1530, the method may include combining a first set of measurement samples associated with the first measurement result and the first measurement result with a second set of measurement samples associated with the second measurement result using the set of weighting factors to obtain the second measurement result, where the measurements and combining are performed for the serving cell or the neighbor cell. The operations of 1530 may be performed in accordance with examples as disclosed herein. In some examples, aspects of the operations of 1530 may be performed by a weighting factor manager 745 as described with reference to FIG. 7.

At 1535, the method may include transmitting a measurement report indicating a combined measurement result that is based on the first measurement result, the second measurement result, a trigger event for the BWP switching, a UE capability, the change of measurement gap configurations associated with the BWP switching, or a combination thereof. The operations of 1535 may be performed in accordance with examples as disclosed herein. In some examples, aspects of the operations of 1535 may be performed by a measurement reporting manager 740 as described with reference to FIG. 7.

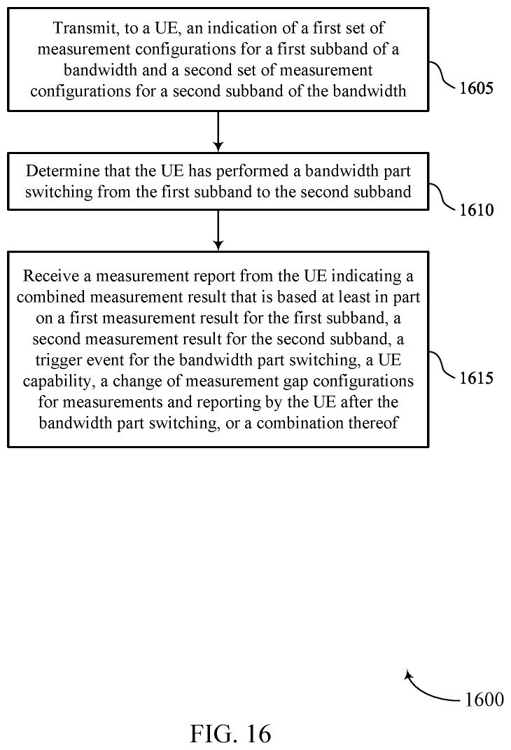

FIG. 16 shows a flowchart illustrating a method 1600 that supports channel measurements and reporting procedures associated with BWP switching in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, an indication of a first set of measurement configurations for a first subband of a bandwidth and a second set of measurement configurations for a second subband of the bandwidth. The operations of 1605 may be performed in accordance with examples as disclosed herein. In some examples, aspects of the operations of 1605 may be performed by a measurement configuration manager 1125 as described with reference to FIG. 11.

At 1610, the method may include determining that the UE has performed a BWP switching from the first subband to the second subband. The operations of 1610 may be performed in accordance with examples as disclosed herein. In some examples, aspects of the operations of 1610 may be performed by a BWP switching manager 1130 as described with reference to FIG. 11.

At 1615, the method may include receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof. The operations of 1615 may be performed in accordance with examples as disclosed herein. In some examples, aspects of the operations of 1615 may be performed by a combined measurement report manager 1135 as described with reference to FIG. 11.

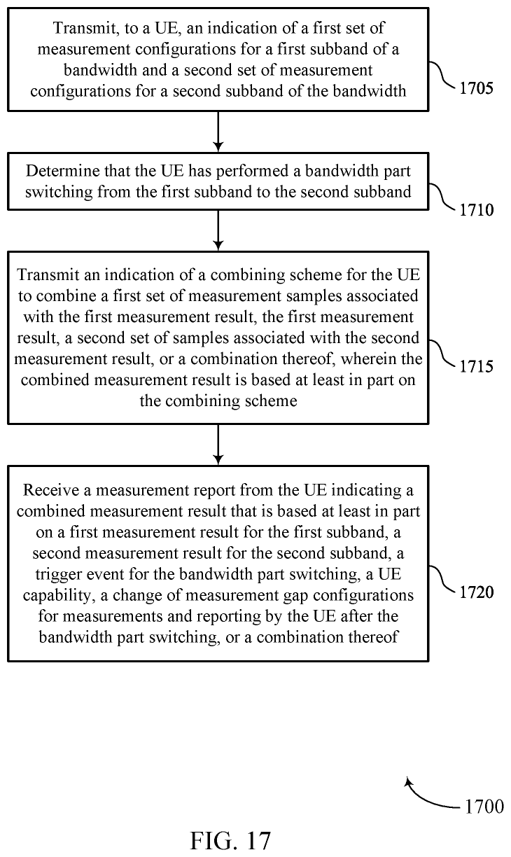

FIG. 17 shows a flowchart illustrating a method 1700 that supports channel measurements and reporting procedures associated with BWP switching in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of a first set of measurement configurations for a first subband of a bandwidth and a second set of measurement configurations for a second subband of the bandwidth. The operations of 1705 may be performed in accordance with examples as disclosed herein. In some examples, aspects of the operations of 1705 may be performed by a measurement configuration manager 1125 as described with reference to FIG. 11.

At 1710, the method may include determining that the UE has performed a BWP switching from the first subband to the second subband. The operations of 1710 may be performed in accordance with examples as disclosed herein. In some examples, aspects of the operations of 1710 may be performed by a BWP switching manager 1130 as described with reference to FIG. 11.

At 1715, the method may include transmitting an indication of a combining scheme for the UE to combine a first set of measurement samples associated with the first measurement result, the first measurement result, a second set of samples associated with the second measurement result, or a combination thereof, where the combined measurement result is based on the combining scheme. The operations of 1715 may be performed in accordance with examples as disclosed herein. In some examples, aspects of the operations of 1715 may be performed by a combining scheme manager 1145 as described with reference to FIG. 11.

At 1720, the method may include receiving a measurement report from the UE indicating a combined measurement result that is based on a first measurement result for the first subband, a second measurement result for the second subband, a trigger event for the BWP switching, a UE capability, a change of measurement gap configurations for measurements and reporting by the UE after the BWP switching, or a combination thereof. The operations of 1720 may be performed in accordance with examples as disclosed herein. In some examples, aspects of the operations of 1720 may be performed by a combined measurement report manager 1135 as described with reference to FIG. 11.

The following provides an overview of aspects of the present disclosure:

Aspect 1: A method for wireless communication at a UE, comprising: performing a first measurement for a serving cell or a neighbor cell in a first subband of a bandwidth using a first set of measurement configurations to obtain a first measurement result; performing BWP switching from the first subband to a second subband of the bandwidth; identifying a change of measurement gap configurations for the serving cell or the neighbor cell associated with the BWP switching; performing a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration; and transmitting a measurement report indicating a combined measurement result that is based at least in part on the first measurement result, the second measurement result, a trigger event for the BWP switching, a UE capability, the change of measurement gap configurations associated with the BWP switching, or a combination thereof.

Aspect 2: The method of aspect 1, further comprising: identifying a set of weighting factors associated with the first subband and the second subband; and combining the first measurement result with a set of measurement samples associated with the second measurement result using the set of weighting factors to obtain the second measurement result, wherein the measurements and combining are performed for the serving cell or the neighbor cell.

Aspect 3: The method of any of aspects 1 through 2, further comprising: identifying a set of weighting factors for measurements associated with the first subband and the second subband; and combining a first set of measurement samples associated with the first measurement result and the first measurement result with a second set of measurement samples associated with the second measurement result using the set of weighting factors to obtain the second measurement result, wherein the measurements and combining are performed for the serving cell or the neighbor cell.

Aspect 4: The method of any of aspects 1 through 3, further comprising: comparing a first set of measurement samples associated with the first measurement result to a measurement threshold; identifying a set of weighting factors associated with the first subband and the second subband; and combining, based at least in part on a result of the comparing, the first set of measurement samples, the first measurement result, a second set of measurement samples associated with the second measurement result, or a combination thereof, using the set of weighting factors to obtain the second measurement result.

Aspect 5: The method of aspect 4, wherein the first set of measurement samples and the second set of measurement samples comprise physical layer measurements, radio resource control layer measurements, or both, that are used to determine one or more measurement results for the serving cell or the neighbor cell.

Aspect 6: The method of any of aspects 1 through 5, further comprising: comparing a time gap between measuring a first set of measurement samples associated with the first measurement result and measuring a second set of measurement samples associated with the second measurement result to a gap threshold; identifying a set of weighting factors associated with the first subband and the second subband; and combining, based at least in part on a result of the comparing, the first set of measurement samples, the first measurement result, a second set of measurement samples associated with the second measurement result, or a combination thereof, using the set of weighting factors to obtain the second measurement result, wherein the measurements and combining are performed for the serving cell and the neighbor cell.

Aspect 7: The method of any of aspects 1 through 6, further comprising: combining, based at least in part on a measurement threshold, a gap threshold, or a combination thereof, a first set of measurement samples associated with the first measurement result, the first measurement result, a second set of measurement samples associated with the second measurement result, or a combination thereof, using a set of weighting factors to obtain the second measurement result, wherein the measurements and combining are performed for the serving cell and the neighbor cell.

Aspect 8: The method of any of aspects 1 through 7, further comprising: combining, based at least in part on a UE capability, a measurement priority, an available UE power headroom, or a combination thereof, a first set of measurement samples associated with the first measurement result, the first measurement result, a second set of measurement samples associated with the second measurement result, or a combination thereof, to obtain the second measurement result for the serving cell or the neighbor cell.

Aspect 9: The method of any of aspects 1 through 8, further comprising: combining a first set of measurement samples associated with the first measurement result, the first measurement result, a second set of measurement samples associated with the second measurement result, or a combination thereof, to obtain the second measurement result for the serving cell or the neighbor cell.

Aspect 10: The method of any of aspects 1 through 9, further comprising: receiving an indication of a combining scheme for combining a first set of measurement samples associated with the first measurement result, the first measurement result, a second set of measurement samples associated with the second measurement result, or a combination thereof, to obtain the second measurement result for the serving cell or the neighbor cell.

Aspect 11: The method of any of aspects 1 through 10, further comprising: determining that a measurement and reporting interval of the first set of measurement configurations overlaps with the BWP switching; suspending measurement and reporting for the serving cell and the neighbor cell during the BWP switching; and transmitting, after the BWP switching and based at least in part on the overlap, a set of UE assistance information messages or scheduling request messages requesting transmission of the first measurement result in the second subband.

Aspect 12: The method of any of aspects 1 through 11, further comprising: determining that a measurement and reporting interval of the first set of measurement configurations overlaps with the BWP switching; suspending measurement and reporting for the serving cell and the neighbor cell during BWP; and multiplexing, after the BWP switching and based at least in part on the overlap, the first measurement result and additional uplink information in a message transmitted in the second subband.

Aspect 13: The method of aspect 12, wherein the first measurement result is indicated in a MAC header of the message.

Aspect 14: The method of any of aspects 1 through 13, further comprising: determining that a measurement and reporting interval of the first set of measurement configurations overlaps with the BWP switching; suspending the measurement and reporting for the serving cell and the neighbor cell during BWP switching; and measuring, after the BWP switching and based at least in part on the overlap, a first set of measurement samples for the serving cell or the neighbor cell using a set of weighting factors to obtain an updated first measurement result, wherein the combined measurement result is based at least in part on the updated first measurement result.

Aspect 15: The method of any of aspects 1 through 14, further comprising: determining that a measurement and reporting interval of the first set of measurement configurations overlaps with the BWP switching; suspending measurement and reporting for the serving cell and the neighbor cell during BWP switching; and comparing, after the BWP switching and based at least in part on the overlap, a timing gap between the first measurement result suspended during BWP switching and the second measurement result to a timing gap threshold, wherein combined measurement result is based at least in part on a result of the comparing.

Aspect 16: The method of any of aspects 1 through 15, further comprising: determining that a measurement and reporting interval of the first set of measurement configurations overlaps with the BWP switching; suspending measurement and reporting for the serving cell and the neighbor cell during BWP switching; and transmitting, after the BWP switching and based at least in part on the overlap, a message requesting transmission of the first measurement result suspended during BWP switching or a message where the first measurement result suspended during BWP switching is multiplexed with additional uplink information based at least in part on a reporting resource size of the second set of measurement configurations, a timing gap threshold between the first measurement result and the second measurement result, or a combination thereof.

Aspect 17: The method of any of aspects 1 through 16, further comprising: determining that a measurement and reporting interval of the first set of measurement configurations overlaps with the BWP switching; suspending measurement and reporting for the serving cell and the neighbor cell during BWP switching; and selecting, after the BWP switching and based at least in part on the overlap, a transmission scheme for reporting the first measurement result based at least in part on a UE capability, a measurement priority of the first measurement result, an available UE power headroom, a measurement gap configuration for the second measurement result, a reporting configuration for the second measurement result, or a combination thereof.

Aspect 18: The method of any of aspects 1 through 17, further comprising: determining that a measurement and reporting interval of the first set of measurement configurations overlaps with the BWP switching; suspending measurement and reporting for the serving cell and the neighbor cell during BWP switching; and autonomously selecting, after the BWP switching and based at least in part on the overlap, a transmission scheme for reporting the first measurement result.

Aspect 19: The method of any of aspects 1 through 18, further comprising: receiving an indication of a transmission scheme for reporting the first measurement result in the second subband; determining that a measurement and reporting interval of the first set of measurement configurations overlaps with the BWP switching; suspending measurement and reporting for the serving cell and the neighbor cell during BWP switching; and transmitting, after the BWP switching and based at least in part on the overlap, the first measurement result according to the transmission scheme.

Aspect 20: The method of any of aspects 1 through 19, further comprising: determining that the first set of measurement configurations is different from the second set of measurement configurations, that a first reporting configuration of the first set of measurement configurations is different from a second reporting configuration of the second set of measurement configurations, or both, and a change of measurement gap configurations for the serving cell or the neighbor cell during BWP switching; and identifying, based at least in part on the determining, a timing gap threshold for reporting the first measurement result in the second subband.

Aspect 21: The method of aspect 20, further comprising: identifying a triggering event triggering the BWP switching, wherein the timing gap threshold is based at least in part on a timing of the triggering event, a type of the trigger event, a UE capability, the measurement gap configurations for the second measurement of the serving cell or the neighbor cell.

Aspect 22: The method of any of aspects 1 through 21, wherein the change of measurement gap configurations comprise a change of a reference signal type, a reference signal resource configuration, a gap configuration, a length of measurements, a number of intra-frequency measurements, a number of inter-frequency measurements, a window configuration, a measurement periodicity, a measurement offset time, a reporting condition, a priority level, or a combination thereof, for the measurement and reporting for the serving cell and the neighbor cell.

Aspect 23: A method for wireless communication at a network entity, comprising: transmitting, to a UE, an indication of a first set of measurement configurations for a first subband of a bandwidth and a second set of measurement configurations for a second subband of the bandwidth; determining that the UE has performed a BWP switching from the first subband to the second subband; and receiving a measurement report from the UE indicating a combined measurement result that is based at least in part on a first measurement result for the first subband, a second measurement result for the second subband, a trigger event for the BWP switching, a UE capability, a change of measurement gap configurations for measurements and reporting by the UE after the BWP switching, or a combination thereof.

Aspect 24: The method of aspect 23, further comprising: transmitting an indication of a set of weighting factors associated with the first subband and the second subband to the UE, wherein the combined measurement result is based at least in part on the set of weighting factors.

Aspect 25: The method of any of aspects 23 through 24, further comprising: transmitting an indication of a combining scheme for the UE to combine a first set of measurement samples associated with the first measurement result, the first measurement result, a second set of samples associated with the second measurement result, or a combination thereof, wherein the combined measurement result is based at least in part on the combining scheme.

Aspect 26: The method of any of aspects 23 through 25, further comprising: transmitting an indication of a timing gap threshold for a timing gap between the first measurement result and the second measurement result, wherein the combined measurement result is based at least in part on the timing gap threshold.

Aspect 27: The method of any of aspects 23 through 26, further comprising: receiving a message from the UE requesting transmission of the first measurement result in the second subband.

Aspect 28: An apparatus for wireless communication at a UE, comprising at least one processor and memory coupled with the processor, the memory storing instructions executable by the at least one processor to cause the UE to perform a method of any of aspects 1 through 22.

Aspect 29: An apparatus for wireless communication at a UE, comprising at least one means for performing a method of any of aspects 1 through 22.

Aspect 30: A non-transitory computer-readable medium storing code for wireless communication at a UE, the code comprising instructions executable by at least one processor to perform a method of any of aspects 1 through 22.

Aspect 31: An apparatus for wireless communication at a network entity, comprising at least one processor; and memory coupled with the processor, the memory storing instructions executable by the at least one processor to cause the network entity to perform a method of any of aspects 23 through 27.

Aspect 32: An apparatus for wireless communication at a network entity, comprising at least one means for performing a method of any of aspects 23 through 27.

Aspect 33: A non-transitory computer-readable medium storing code for wireless communication at a network entity, the code comprising instructions executable by at least one processor to perform a method of any of aspects 23 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
perform a first measurement for a serving cell or a neighbor cell in a first subband of a bandwidth using a first set of measurement configurations to obtain a first measurement result;
perform bandwidth part switching from the first subband to a second subband of the bandwidth, the bandwidth part switching comprising a change of measurement gap configurations for the serving cell or the neighbor cell associated with the bandwidth part switching;
perform a second measurement for the serving cell or the neighbor cell in the second subband of the bandwidth using a second set of measurement configurations to obtain a second measurement result, the first set of measurement configurations and the second set of measurement configurations being different measurement configurations that have a common or different measurement filtering configuration; and
transmit a measurement report indicating a combined measurement result that is based at least in part on the first measurement result, the second measurement result, a trigger event for the bandwidth part switching, a UE capability, the change of measurement gap configurations associated with the bandwidth part switching, or a combination thereof.

2. The apparatus of claim 1, wherein the instructions are further executable by the at least one processor to cause the UE to:
combine the first measurement result with a set of measurement samples associated with the second measurement result using a set of weighting factors associated with the first subband and the second subband to obtain the second measurement result, wherein the measurements and combining are performed for the serving cell or the neighbor cell.

3. The apparatus of claim 1, wherein the instructions are further executable by the at least one processor to cause the UE to:
combine a first set of measurement samples associated with the first measurement result and the first measurement result with a second set of measurement samples associated with the second measurement result using a set of weighting factors associated with the first subband and the second subband to obtain the second measurement result, wherein the measurements and combining are performed for the serving cell or the neighbor cell.

4. The apparatus of claim 1, wherein the instructions are further executable by the at least one processor to cause the UE to:
compare a first set of measurement samples associated with the first measurement result to a measurement threshold; and
combine, based at least in part on a result of the comparing, the first set of measurement samples, the first measurement result, a second set of measurement samples associated with the second measurement result, or a combination thereof, using a set of weighting factors associated with the first subband and the second subband to obtain the second measurement result.

5. The apparatus of claim 4, wherein the first set of measurement samples and the second set of measurement samples comprise physical layer measurements, radio resource control layer measurements, or both, that are used to determine one or more measurement results for the serving cell or the neighbor cell.

6. The apparatus of claim 1, wherein the instructions are further executable by the at least one processor to cause the UE to:
compare a time gap between measuring a first set of measurement samples associated with the first measurement result and measuring a second set of measurement samples associated with the second measurement result to a gap threshold;
identify a set of weighting factors associated with the first subband and the second subband; and
combine, based at least in part on a result of the comparing, the first set of measurement samples, the first measurement result, a second set of measurement samples associated with the second measurement result, or a combination thereof, using a set of weighting factors associated with the first subband and the second subband to obtain the second measurement result, wherein the measurements and combining are performed for the serving cell and the neighbor cell.

7. The apparatus of claim 1, wherein the instructions are further executable by the at least one processor to cause the UE to:
combine, based at least in part on a measurement threshold, a gap threshold, or a combination thereof, a first set of measurement samples associated with the first measurement result, the first measurement result, a second set of measurement samples associated with the second measurement result, or a combination thereof, using a set of weighting factors to obtain the second measurement result, wherein the measurements and combining are performed for the serving cell and the neighbor cell.

8. The apparatus of claim 1, wherein the instructions are further executable by the at least one processor to cause the UE to:
combine, based at least in part on a UE capability, a measurement priority, an available UE power headroom, or a combination thereof, a first set of measurement samples associated with the first measurement result, the first measurement result, a second set of measurement samples associated with the second measurement result, or a combination thereof, to obtain the second measurement result for the serving cell or the neighbor cell.

9. The apparatus of claim 1, wherein the instructions are further executable by the at least one processor to cause the UE to:
combine a first set of measurement samples associated with the first measurement result, the first measurement result, a second set of measurement samples associated with the second measurement result, or a combination thereof, to obtain the second measurement result for the serving cell or the neighbor cell.

10. The apparatus of claim 1, wherein the instructions are further executable by the at least one processor to cause the UE to:
receive an indication of a combining scheme for combining a first set of measurement samples associated with the first measurement result, the first measurement result, a second set of measurement samples associated with the second measurement result, or a combination thereof, to obtain the second measurement result for the serving cell or the neighbor cell.

11. The apparatus of claim 1, wherein the instructions are further executable by the at least one processor to cause the UE to:
suspend measurement and reporting for the serving cell and the neighbor cell during the bandwidth part switching based at least in part on a measurement and reporting interval of the first set of measurement configurations overlapping with the bandwidth part switching; and
transmit, after the bandwidth part switching and based at least in part on the overlap, a set of UE assistance information messages or scheduling request messages requesting transmission of the first measurement result in the second subband.

12. The apparatus of claim 1, wherein the instructions are further executable by the at least one processor to cause the UE to:
suspend measurement and reporting for the serving cell and the neighbor cell during bandwidth part based at least in part on a measurement and reporting interval of the first set of measurement configurations overlapping with the bandwidth part switching; and
multiplex, after the bandwidth part switch and base at least in part on the overlap, the first measurement result and additional uplink information in a message transmitted in the second subband.

13. The apparatus of claim 12, wherein the first measurement result is indicated in a medium access control (MAC) header of the message.

14. The apparatus of claim 1, wherein the instructions are further executable by the at least one processor to cause the UE to:
suspend the measurement and reporting for the serving cell and the neighbor cell during bandwidth part switching based at least in part on a measurement and reporting interval of the first set of measurement configurations overlapping with the bandwidth part switching; and
measure, after the bandwidth part switching and based at least in part on the overlap, a first set of measurement samples for the serving cell or the neighbor cell using a set of weighting factors to obtain an updated first measurement result, wherein the combined measurement result is based at least in part on the updated first measurement result.

15. The apparatus of claim 1, wherein the instructions are further executable by the at least one processor to cause the UE to:
suspend measurement and reporting for the serving cell and the neighbor cell during bandwidth part switching based at least in part on a measurement and reporting interval of the first set of measurement configurations overlapping with the bandwidth part switching; and
compare, after the bandwidth part switching and based at least in part on the overlap, a timing gap between the first measurement result suspended during bandwidth part switching and the second measurement result to a timing gap threshold, wherein combined measurement result is based at least in part on a result of the comparing.

16. The apparatus of claim 1, wherein the instructions are further executable by the at least one processor to cause the UE to:
suspend measurement and reporting for the serving cell and the neighbor cell during bandwidth part switching based at least in part on a measurement and reporting interval of the first set of measurement configurations overlaps with the bandwidth part switching; and
transmit, after the bandwidth part switching and based at least in part on the overlap, a message requesting transmission of the first measurement result suspended during bandwidth part switching or a message where the first measurement result suspended during bandwidth part switching is multiplexed with additional uplink information based at least in part on a reporting resource size of the second set of measurement configurations, a timing gap threshold between the first measurement result and the second measurement result, or a combination thereof.

17. The apparatus of claim 1, wherein the instructions are further executable by the at least one processor to cause the UE to:
suspend measurement and reporting for the serving cell and the neighbor cell during bandwidth part switching based at least in part on a measurement and reporting interval of the first set of measurement configurations overlapping with the bandwidth part switching; and
select, after the bandwidth part switching and based at least in part on the overlap, a transmission scheme for reporting the first measurement result based at least in part on a UE capability, a measurement priority of the first measurement result, an available UE power headroom, a measurement gap configuration for the second measurement result, a reporting configuration for the second measurement result, or a combination thereof.

18. The apparatus of claim 1, wherein the instructions are further executable by the at least one processor to cause the UE to:
suspend measurement and reporting for the serving cell and the neighbor cell during bandwidth part switching based at least in part on a measurement and reporting interval of the first set of measurement configurations overlapping with the bandwidth part switching; and
autonomously select, after the bandwidth part switching and based at least in part on the overlap, a transmission scheme for reporting the first measurement result.

19. The apparatus of claim 1, wherein the instructions are further executable by the at least one processor to cause the UE to:
receive an indication of a transmission scheme for reporting the first measurement result in the second subband;
suspend measurement and reporting for the serving cell and the neighbor cell during bandwidth part switching based at least in part on a measurement and reporting interval of the first set of measurement configurations overlapping with the bandwidth part switching; and
transmit, after the bandwidth part switching and based at least in part on the overlap, the first measurement result according to the transmission scheme.

20. The apparatus of claim 1, wherein the instructions are further executable by the at least one processor to cause the UE to:
determine that the first set of measurement configurations is different from the second set of measurement configurations, that a first reporting configuration of the first set of measurement configurations is different from a second reporting configuration of the second set of measurement configurations, or both, and a change of measurement gap configurations for the serving cell or the neighbor cell during bandwidth part switching; and
identify, based at least in part on the determining, a timing gap threshold for reporting the first measurement result in the second subband.

21. The apparatus of claim 20, wherein the instructions are further executable by the at least one processor to cause the UE to:
identify a triggering event triggering the bandwidth part switching, wherein the timing gap threshold is based at least in part on a timing of the triggering event, a type of the trigger event, a UE capability, the measurement gap configurations for the second measurement of the serving cell or the neighbor cell.

22. The apparatus of claim 1, wherein the change of measurement gap configurations comprise a change of a reference signal type, a reference signal resource configuration, a gap configuration, a length of measurements, a number of intra-frequency measurements, a number of inter-frequency measurements, a window configuration, a measurement periodicity, a measurement offset time, a reporting condition, a priority level, or a combination thereof, for the measurement and reporting for the serving cell and the neighbor cell.

23. An apparatus for wireless communication at a network entity, comprising:
at least one processor; and
at least one memory coupled with the at least one processor, the memory storing instructions executable by the at least one processor to cause the network entity to:
transmit, to a user equipment (UE), an indication of a first set of measurement configurations for a first subband of a bandwidth and a second set of measurement configurations for a second subband of the bandwidth; and
receive, based at least in part on the UE performing a bandwidth part switching from the first subband to the second subband, a measurement report from the UE indicating a combined measurement result that is based at least in part on a first measurement result for the first subband, a second measurement result for the second subband, a trigger event for the bandwidth part switching, a UE capability, a change of measurement gap configurations for measurements and reporting by the UE after the bandwidth part switching, or a combination thereof.

24. The apparatus of claim 23, wherein the instructions are further executable by the at least one processor to cause the network entity to:
transmit an indication of a set of weighting factors associated with the first subband and the second subband to the UE, wherein the combined measurement result is based at least in part on the set of weighting factors.

25. The apparatus of claim 23, wherein the instructions are further executable by the at least one processor to cause the network entity to:
transmit an indication of a combining scheme for the UE to combine a first set of measurement samples associated with the first measurement result, the first measurement result, a second set of samples associated with the second measurement result, or a combination thereof, wherein the combined measurement result is based at least in part on the combining scheme.

26. The apparatus of claim 23, wherein the instructions are further executable by the at least one processor to cause the network entity to:
transmit an indication of a timing gap threshold for a timing gap between the first measurement result and the second measurement result, wherein the combined measurement result is based at least in part on the timing gap threshold.

27. The apparatus of claim 23, wherein the instructions are further executable by the at least one processor to cause the network entity to:
receive a message from the UE requesting transmission of the first measurement result in the second subband.

28. A method for wireless communication at a user equipment (UE), comprising:
performing a first measurement for a serving cell or a neighbor cell in a first subband of a bandwidth using a first set of measurement configurations to obtain a first measurement result;
performing bandwidth part switching from the first subband to a second subband of the bandwidth, the bandwidth part switching comprising a change of measurement gap configurations for the serving cell or the neighbor cell associated with the bandwidth part switching;
performing a second measurement for the serving cell or the neighbor cell in the second subband of the bandwidth using a second set of measurement configurations to obtain a second measurement result, the first set of measurement configurations and the second set of measurement configurations being different measurement configurations; and
transmitting a measurement report indicating a combined measurement result that is based at least in part on the first measurement result, the second measurement result, a trigger event for the bandwidth part switching, a UE capability, the change of measurement gap configurations associated with the bandwidth part switching, or a combination thereof.

29. The method of claim 28, further comprising:
combining the first measurement result with a set of measurement samples associated with the second measurement result using a set of weighting factors associated with the first subband and the second subband to obtain the second measurement result, wherein the measurements and combining are performed for the serving cell or the neighbor cell.

30. A method for wireless communication at a network entity, comprising:
transmitting, to a user equipment (UE), an indication of a first set of measurement configurations for a first subband of a bandwidth and a second set of measurement configurations for a second subband of the bandwidth; and
receiving, based at least in part on the UE performing a bandwidth part switching from the first subband to the second subband, a measurement report from the UE indicating a combined measurement result that is based at least in part on a first measurement result for the first subband, a second measurement result for the second subband, a trigger event for the bandwidth part switching, a UE capability, a change of measurement gap configurations for measurements and reporting by the UE after the bandwidth part switching, or a combination thereof.
